(19) United States
(12) Patent Application Publication
(10) Pub. No.: US 2009/0271839 A1
(43) Pub. Date: Oct. 29, 2009

(54) Document Security System

(76) Inventors: Yoichi Kanai, Kanagawa (JP); Yusuke Ohta, Kanagawa (JP); Atsuhisa Saitoh, Kanagawa (JP)

Correspondence Address: DICKSTEIN SHAPIRO LLP, 1825 EYE STREET NW, Washington, DC, 20006-5403, US

(21) Appl. No.: 11/922,109

(22) PCT Filed: May 2, 2007
(86) PCT No.: PCT/JP2007/059802

§ 371 Date: Dec. 13, 2007

(30) Foreign Application Priority Data
May 2, 2006 (JP) 2006-128557

(51) Int. Cl. G06K 15/00; G06F 17/21

(52) U.S. Cl. 726/1; 358/1.14

(57) ABSTRACT

A document security system is disclosed. In the document security system, when a user is permitted to use a device and to use a document, a process for the document requested by a user is executed by the device. Further, after executing the process, a follow-up obligation is executed corresponding to the type of the document obtained from image data of the document.

### TECHNICAL FIELD

The present invention generally relates to a document security system in which a document job requested by a user is executed when the user is permitted to use a document processing device based on a using right of the device and to execute the job based on a using right of the document, and an obligation is executed corresponding to the type of the document obtained from image data of the document.

### BACKGROUND ART

Recently, the importance of maintaining the security of a document has been largely recognized and the necessity to keep corporate secrets has been enhanced. In addition to in an electronic document processed on a personal computer, in a document printed from the electronic document and a document transmitted or received by a facsimile, necessity of maintaining the security of the document has been increased.

Especially, in an image processing apparatus having plural functions which process a paper document and an electronic document, necessity of maintaining the security of the document has been increased.

In Patent Documents 1 and 2, and Non-Patent document 1, when a secret document is printed, a pattern for identifying the secret document is automatically printed on a background of the secret document according to a security policy, and when the printed secret document is copied or scanned by an image processing apparatus, the image processing apparatus identifies the pattern on the background and determines whether the document is copied or scanned according to the security policy.

In Patent Document 3, when a document is copied, scanned, or transmitted by a facsimile function in an image processing apparatus, the image processing apparatus instantly determines whether the scanned document has a specific background by image matching, and controls processes of copying, scanning, or transmitting by the facsimile function based on the determined result.

In Patent Document 4, a pattern preventing copying is attached to image data of a read document; in addition, a barcode is attached to a document to be processed or later processed, and the document is prevented from being processed.

In Non-Patent Document 2, an administrator determines a person who can use functions of copying, printing, and scanning.

In Non-Patent Document 3, in a case where an image is copied, when a specific mask pattern is detected during the copying, the image is broken.

[Patent Document 1] Japanese Laid-Open Patent Application No. 2005-038372

[Patent Document 2] Japanese Laid-Open Patent Application No. 2004-152261

[Patent Document 3] Japanese Laid-Open Patent Application No. 2004-200897

[Patent Document 4] Japanese Laid-Open Patent Application No. 2005-072777

[Non-Patent Document 1] Development of System to Maintain Security of Paper and Electronic Documents corresponding to Policy, IPSJ Symposium Series Vol. 2004, No. 11, pp. 661-666, by Kanai and Saitoh

[Non-Patent Document 2] Unauthorized Use Preventing System by Restricting Use of Function, <URL: http//www.ricoh.co.jp/imagio/neo_c/455/point/point6.html>

[Non-Patent Document 3] Unauthorized Copy Preventing Function, <URL: http//www.ricoh.co.jp/imagio/neo/753/Point/point4.html>

In Non-Patent Document 2, in a system maintaining security of a document when the document is processed by an image processing apparatus, functions such as a copying function, a facsimile function, and a scanning function are limited to authorized persons.

However, in the above system, a user having authority for copying a document can freely copy a secret document. That is, maintaining the security of the secret document is not sufficient.

In addition, in Patent Documents 3 and 4, when a secret document is printed, a specific background pattern is printed together with the secret document. In a case where the printed secret document having the specific background pattern is tried to be copied, when the image of the secret document is read, the specific background pattern is detected in real time. Or the image to be output is changed by the detected result. For example, in Patent Document 3, the image is output with gray all over.

However, in the above methods, the number of the secret documents to be processed is limited to the number of the specific background patterns. For example, when a specific background pattern is provided for a confidential document, the method is used so that only administrators can copy the confidential document; however, when users are classified into several levels and the number of the secret documents is increased, the number of the specific background patterns is not sufficient.

In Non-Patent Document 1 and Patent Document 1, when a paper document is copied by an image processing apparatus, a traceable ID embedded in the background of the paper document is detected and copying the paper document is determined by querying a server of the traceable ID.

However, since the query is sent to the server located far away, in a high-speed image processing apparatus capable of copying 100 pages or more per minute, it is very difficult to identify the traceable IDs and determine whether the paper documents are copied in real time in the high-speed operations.

In addition, in Patent Document 2, when an electronic document encrypted as a secret document is printed, a specific printing method is forcibly used corresponding to the security policy. For example, a specific pattern is added to the background of the electronic document.

However, when other documents which are not encrypted as secret documents are printed, the documents are printed without the specific patterns. For example, a draft including secret information is not printed with the specific pattern. Therefore, although the draft includes the secret information, the draft can be copied as a general document.

### DISCLOSURE OF THE INVENTION

The present invention solves one or more of the problems in the conventional technologies. According to an embodiment of the present invention, there is provided a document security system which controls processes for a paper document in real time without restricting the use of functions of an image processing apparatus and lowering operating speed in the image processing apparatus and integrally controls executing a process after the above process by analyzing the contents of the paper document based on the security policy.

According to one aspect of the present invention, there is provided a document security system. The document security system includes a receiving unit which receives a request for processing a document from a user, a first determined result obtaining unit which obtains a first determined result by determining whether the process requested according to a device using right of the user is given a permission for processing by referring to a device security policy in which the device using right of the user is defined, a document type determining unit which determines the type of the document based on identifying information by obtaining the identifying information attached to the document from image data obtained by scanning the document, a second determined result obtaining unit which obtains a second determined result by determining whether the type of the document determined by the document type determining unit is permitted to perform the process requested by the request by referring to a document security policy in which the document using right of the user is defined, a process executing unit which executes the process for the document requested by the user when both the first determined result and the second determined result is affirmative, an analyzing unit which analyzes the image data obtained by scanning the document, and a follow-up obligation executing unit which executes a follow-up obligation according to the document security policy based on information obtained by the analyzing unit after executing the process for the document requested by the user.

According to another aspect of the present invention, there is provided a digital multifunctional apparatus. The digital multifunctional apparatus includes a real time paper document determining unit which determines the type of a paper document based on identifying information by obtaining the identifying information attached to the paper document from image data obtained by scanning the paper document, a document using right determining unit which determines whether a user who requests to process the paper document has a document using right for using the paper document for processing the paper document of the type of the paper document determined by the real time paper document determining unit by referring to a document security policy in which the document using right of the user is defined, a paper document processing unit which processes the paper document by changing process contents based on a determined result by the document using right determining unit, and a paper document detail policy determination process requesting unit which sends a detail policy determination process request including the process contents for the paper document to a predetermined destination.

According to an embodiment of the present invention, in a document security system, a paper document is processed in real time without restricting the use of functions of an image processing apparatus and lowering operating speed in the image processing apparatus and integrally controls executing an obligation process after the above processes by analyzing the contents of the paper document based on the security policy.

The features and advantages of the present invention will become more apparent from the following detailed description of a preferred embodiment given with reference to the accompanying drawings.

### BRIEF DESCRIPTION OF THE DRAWINGS

FIG. 1 is a network structure of a document security system according to an embodiment of the present invention

FIG. 2 is a process flow for maintaining security of an original document;

FIG. 3 is a process flow for printing a secured document;

FIG. 4 is a process flow for copying a paper document, scanning the paper document, or transmitting the paper document by a facsimile function in a digital multifunctional apparatus;

FIG. 5 is a diagram showing a structure and a process flow for maintaining security of the original document;

FIG. 6 is a diagram showing a process for forming the secured document by a document security program;

FIG. 7 is a process flow for accessing the secured document;

FIG. 8 is a process flow for scanning a paper manuscript;

FIG. 9 is a table showing a rule of permission and non-permission for scanning the paper manuscript by a user in combinations of a document security policy and a device security policy;

FIG. 10 is a table showing an example of obligation merging rules;

FIG. 11 is a sequence chart showing processes to scan the paper manuscript;

FIG. 12 is a diagram showing an example of structure of the device security policy;

FIG. 13 is a diagram showing an example of a device security attribute database;

FIG. 14 is a diagram showing a first part of the structure of the document security policy;

FIG. 15 is a diagram showing a second part of the structure of the document security policy;

FIG. 16 is a diagram showing a third part of the structure of the document security policy;

FIG. 17 is a diagram showing a fourth part of the structure of the document security policy;

FIG. 18 is a diagram showing an example of a screen for setting a fundamental document policy;

FIG. 19 is a diagram showing an example of a screen for setting a policy for a paper document;

FIG. 20 is a diagram showing an example of a structure of a document security attribute database;

FIG. 21 is a diagram showing processes to be executed by a scanning program;

FIG. 22 is a diagram showing processes to be executed by a policy server A;

FIG. 23 is a diagram showing processes to be executed after the processes shown in FIG. 22 by the policy server A;

FIG. 24 is a sequence chart showing processes to scan the paper manuscript in which scanned data are sent to the policy server A program right before the end of the scanning processes;

FIG. 25 is a diagram showing processes to be executed by the scanning program in a case where a detail policy determination process is executed after executing an obligation;

FIG. 26 is a diagram showing processes of a document using right determination process to be executed by the policy server A program in a case where a detail policy determination process is executed after executing an obligation;

FIG. 27 is a diagram showing processes in the detail policy determination process to be executed by the policy server A program after executing an obligation;

FIG. 28 is a diagram showing an example of first alert mail which is sent to an administrator as an obligation when a general document is copied;

FIG. 29 is a diagram showing an example of second alert mail which is sent to the administrator as an obligation when a paper document printed from a secured document is copied; and

FIG. 30 is a diagram showing an example of third alert mail which is sent to the administrator as a follow-up obligation when a paper document printed from an original document is scanned.

### BEST MODE FOR CARRYING OUT THE INVENTION

Next, referring to the drawings, an embodiment of the present invention is described in detail.

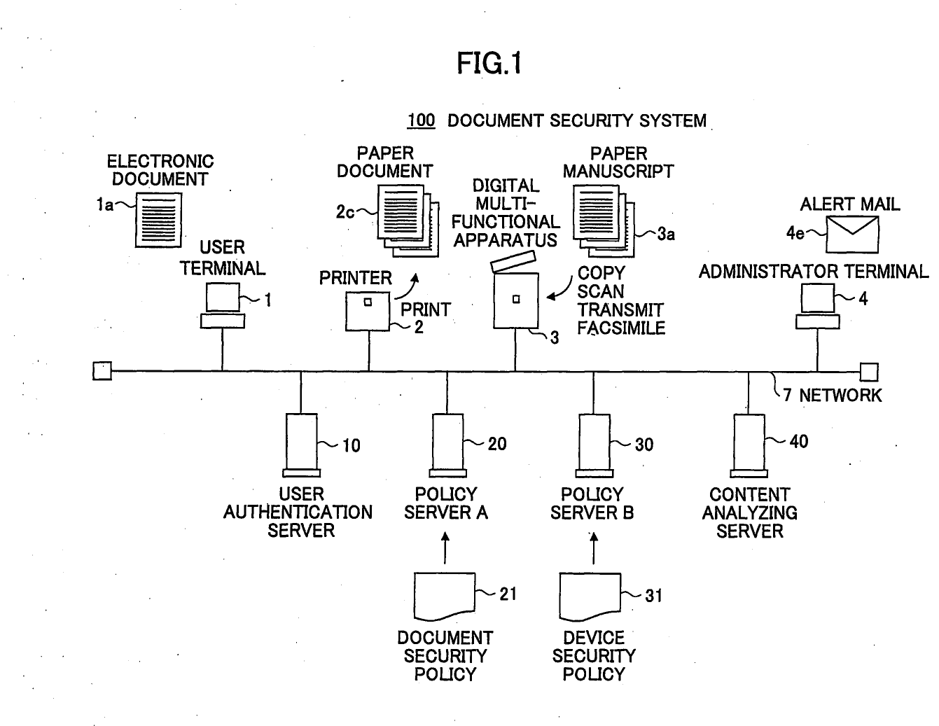

FIG. 1 is a network structure of a document security system 100 according to the embodiment of the present invention. As shown in FIG. 1, the document security system 100 includes a user terminal 1, a printer 2, a digital multifunctional apparatus 3, an administrator terminal 4; and a server group including a user authentication server 10, a policy server A 20, a policy server B 30, and a content analyzing server 40 that are operated as back-end services. In addition, the document security system 100 includes a network 7, and the above elements are connected to each other via the network 7.

The user terminal 1 is used by a general user for handling an electronic document 1a. The printer 2 is used to print out a paper document 2c. The digital multifunctional apparatus 3 is an image processing apparatus having multiple functions such as copying a paper manuscript 3a, scanning the paper manuscript 3a, and transmitting the paper manuscript 3a by a facsimile function. The administrator terminal 4 is used by an administrator of the document security system 100 and is a destination of alert mail 4e.

The user authentication server 10 manages user authentication information and authenticates a user. The policy server A 20 manages a document security policy 21 which manages document using rights of users. The policy server B 30 manages a device security policy 31 which manages device using rights of users. The content analyzing server 40 manages an original digital document.

Each of the user terminal 1, the printer 2, the digital multifunctional apparatus 3, the administrator terminal 4, the user authentication server 10, the policy server A 20, the policy server B 30, and the content analyzing server 40 provides at least a CPU (central processing unit), a memory unit, storage which stores programs (described below), a communication unit for communicating via the network 7, an input unit, and a display unit.

In FIG. 1, in order to describe the functions in the document security system 100, the several elements are shown; however, one element can include several functions. For example, one terminal can include the user terminal 1 and the administrator terminal 4, and one apparatus can include the printer 2 and the digital multifunctional apparatus 3. Further, one server can include the user authentication server 10, the policy server A 20, and the policy server B 30.

When the document security system 100 is established as an expanded system of a DRM (digital rights management) system, the performance of the document security system 100 can be high. Therefore, in the embodiment of the present invention, the document security system 100 is established based on the DRM system.

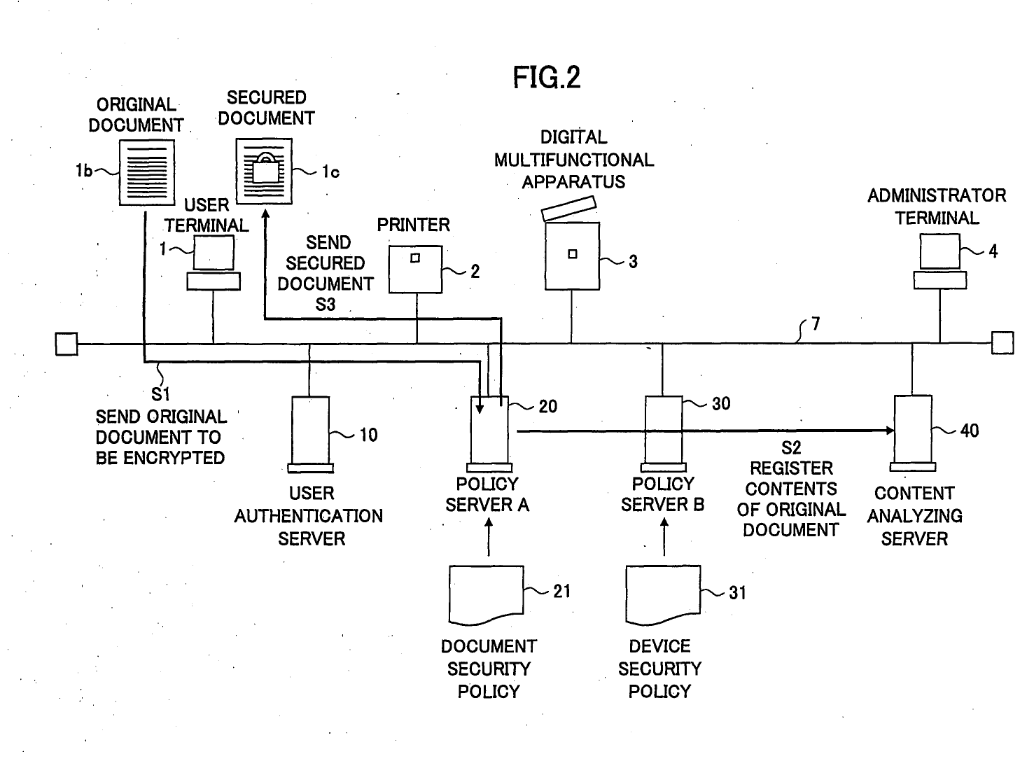

First, referring to FIGS. 2 through 4, basic process flows of the document security system 100 are described. FIG. 2 is a process flow for maintaining security of an original document. First, when the user terminal 1 sends an original document 1b as a confidential document to be encrypted to the policy server A 20 (S1), the policy server A 20 forms a secured document 1c in which the original document 1b is encrypted. Further, the policy server A 20 registers the contents of the original document 1b in the content analyzing server 40 (S2). Then the policy server A 20 sends the secured document 1c to the user terminal 1 (S3).

In the registration of the contents of the original document 1b in the content analyzing server 40, the policy server A 20 registers the original document 1b and security attributes such as the document ID and the security level, and the content analyzing server 40 extracts text from the original document 1b.

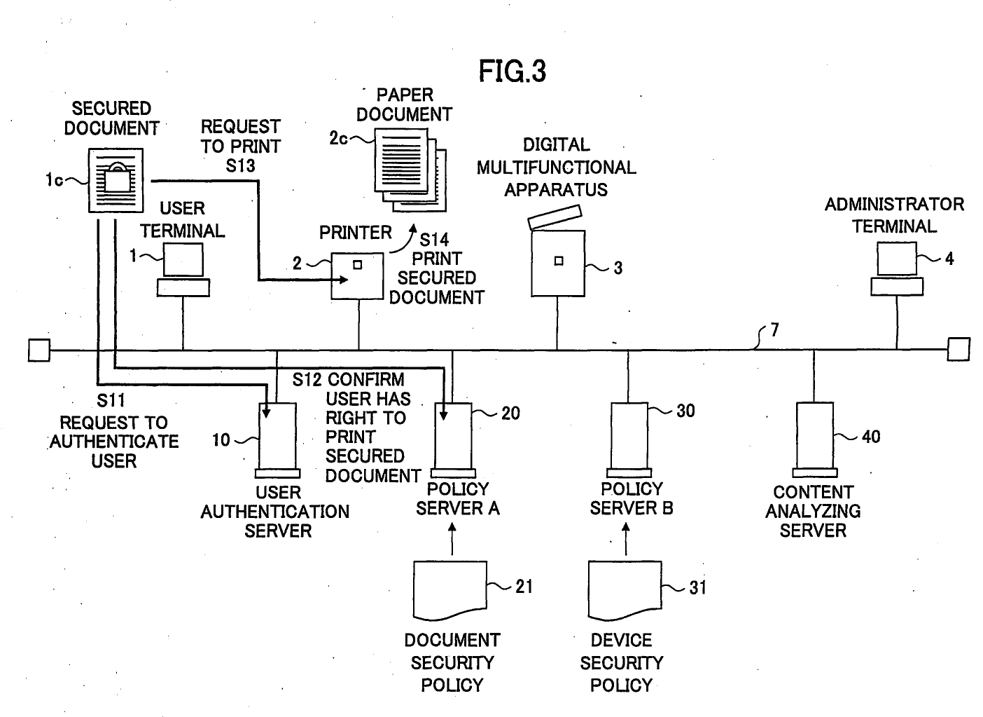

FIG. 3 is a process flow for printing a secured document. In FIG. 3, when the user terminal 1 desires to print the secured document 1c, the user of the user terminal 1 requests the user authentication server 10 to authenticate the user (S11). Further, the user of the user terminal 1 is confirmed to have a right for printing the secured document 1c by the policy server A 20 (S12). When the user of the user terminal 1 is confirmed to have the right, the policy server A 20 sends a decryption key to the user terminal 1.

The user terminal 1 receives the decryption key and requests the printer 2 to print the secured document 1c by applying a security policy designated by the document security policy 21 (S13). The printer 2 prints the secured document 1c as the paper document 2c (S14).

When a security maintaining print such as “Copy Protection against Unauthorized Copy” is defined in the document security policy 21 beforehand, the paper document 2c is printed with a specific pattern on the background.

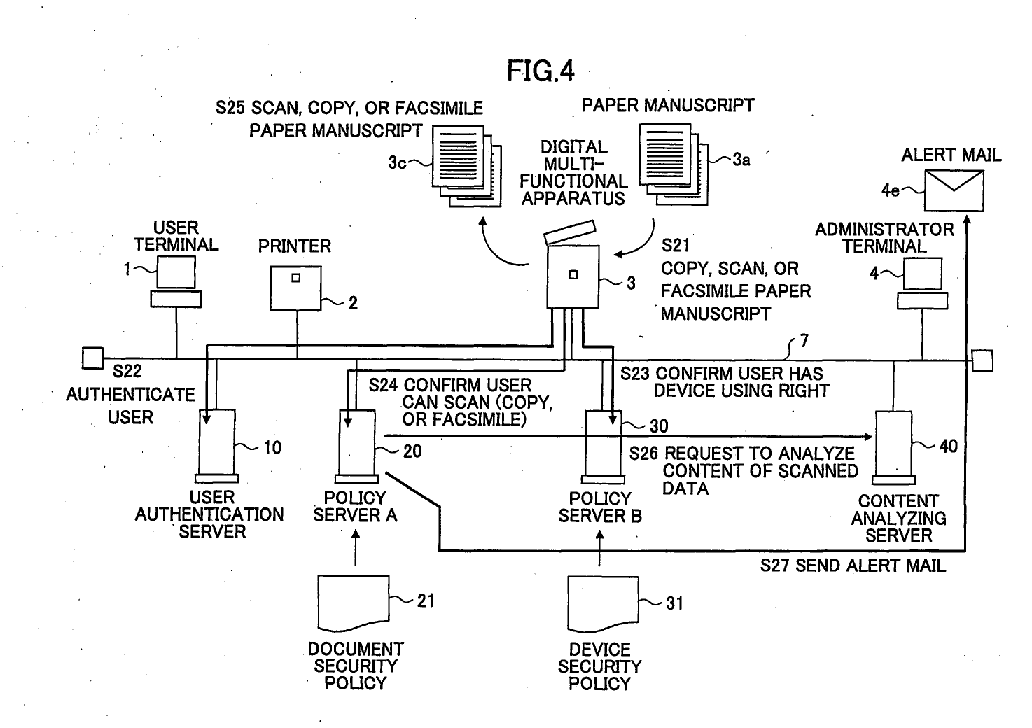

FIG. 4 is a process flow for copying a paper document, scanning the paper document, or transmitting the paper document by the facsimile function in the digital multifunctional apparatus 3. In FIG. 4, when a user desires to scan a paper manuscript 3a (or copy the paper manuscript 3a, or transmit the paper manuscript 3a by the facsimile function) on the digital multifunctional apparatus 3 (S21), the user of the digital multifunctional apparatus 3 is authenticated by the user authentication server 10 (S22). The digital multifunctional apparatus 3 confirms the policy server B 30 that the user has a right to scan the paper manuscript 3a (S23). When the user has the right, the digital multifunctional apparatus 3 scans the paper manuscript 3a and detects a specific pattern when the specific pattern is merged with image data of the paper manuscript 3a.

The digital multifunctional apparatus 3 confirms with the policy server A 20 that the user can scan the paper manuscript 3a on which the specific pattern is merged (S24); when the user can scan the paper manuscript 3a based on the confirmed result, the digital multifunctional apparatus 3 scans the paper manuscript 3a (S25) and outputs scanned data of the paper manuscript 3a to a destination designated by the user.

The policy server A 20 requests the content analyzing server 40 to analyze the contents of the image data of the scanned paper manuscript 3a (S26). When the paper manuscript 3a is prevented from being scanned based on the analyzed result, the policy server A 20 sends alert mail to the administrator terminal 4 (S27).

As described above, in the embodiment of the present invention, when the paper manuscript 3a is processed, the security policy is confirmed in real time, and after that, the security policy is again confirmed by analyzing the contents of the paper manuscript 3a.

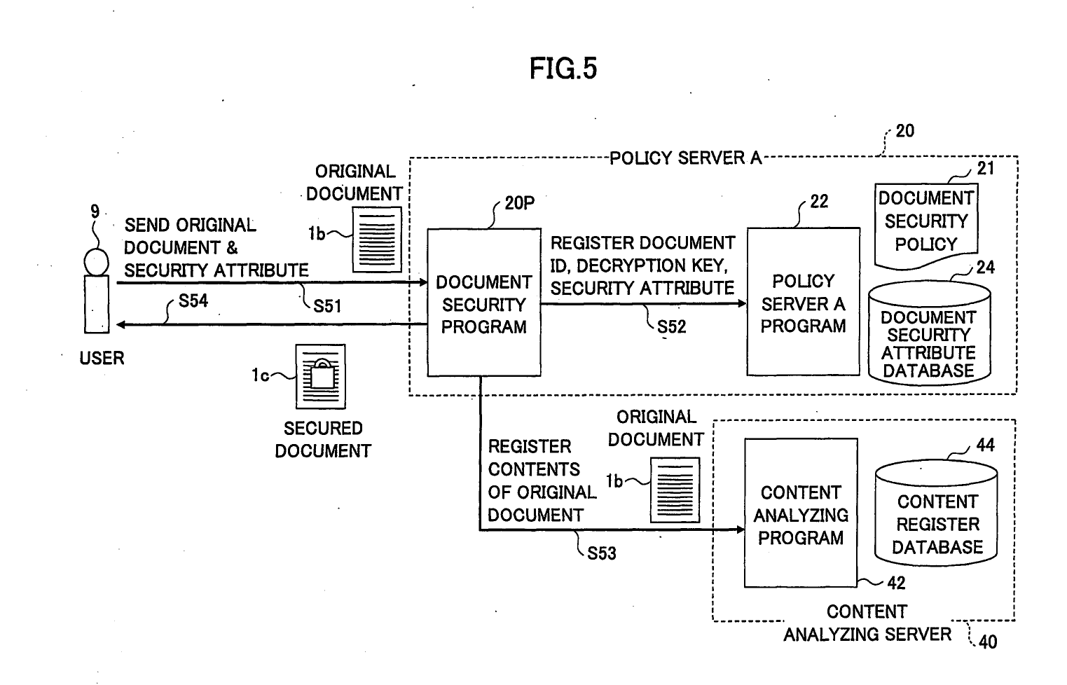

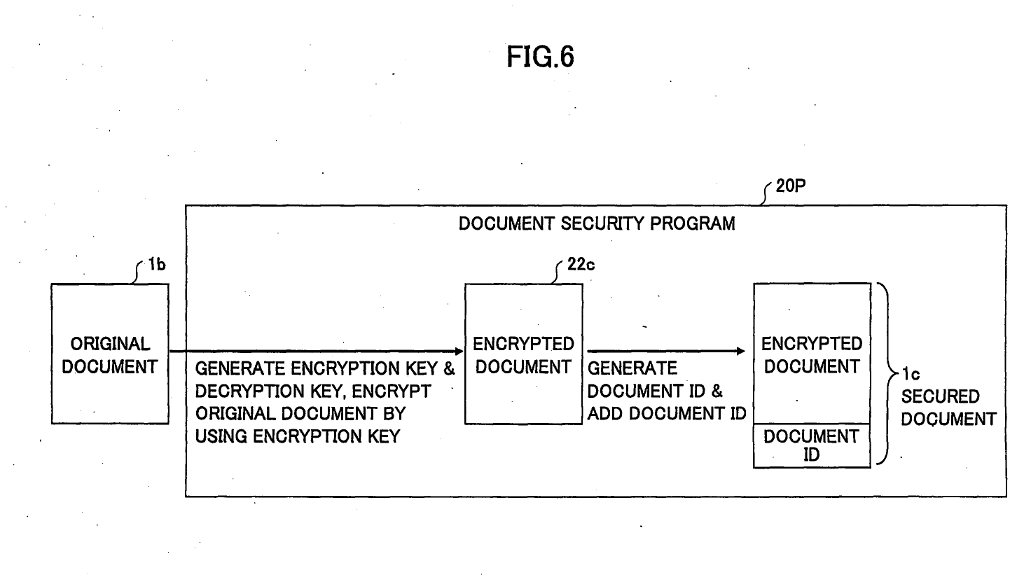

Next, referring to FIGS. 5 and 6, a structure and a process flow for maintaining the security of the original document 1b are described. FIG. 5 is a diagram showing the structure and the process flow for maintaining the security of the original document 1b. FIG. 6 is a diagram showing a process for forming a secured document by a document security program.

As shown in FIG. 5, the policy server A 20 provides a document security program 20P, the document security policy 21, a policy server A program 22, and a document security attribute database 24. The content analyzing server 40 provides a content analyzing program 42 and a content register database 44.

A user 9 sends an original document 1b and security attributes thereof to the document security program 20P (S51). The security attributes include a domain to which the original document 1b belongs, a category of the original document 1b, the security levels, information of persons relating to the original document 1b, and so on.

As shown in FIG. 6, the document security program 20P generates an encryption key and a decryption key, and forms an encrypted document 22c by encrypting the original document 1b while using the encryption key. Further, the document security program 20P generates a unique document ID for identifying a document and forms a secured document 1c by adding the unique document ID to the encrypted document 22c.

The document security program 20P registers the document ID, the decryption key, and the security attributes in the policy server A program 22 (S52). Further, the document security program 20P sends the document ID, the security attributes, and the original document 1b to the content analyzing program 42 in the content analyzing server 40, and registers the contents (the document ID, the security attributes) of the original document 1b in the content register database 44 (S53). Then the document security program 20P sends the secured document 1c to the user 9 (S54).

As described above, when the original document 1b is encrypted and the security thereof is maintained, the contents including the document ID, and the security attributes of the original document 1b are registered in the content register database 44. That is, in the content register database 44, information is registered in which information the document category, the security level, and so on of the original document 1b are described.

By the above process flows, the secured document 1c is formed. Then the user 9 can send the secured document 1c to another user 9.

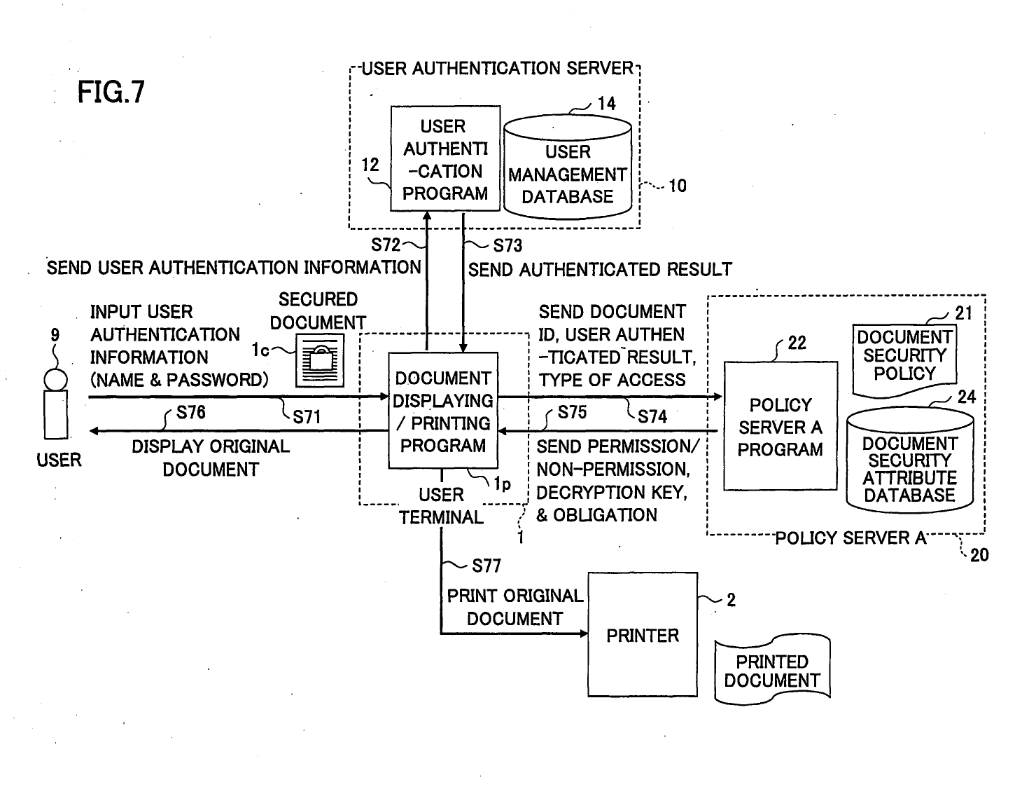

Next, a process flow is described in which the user 9 accesses the secured document 1c after receiving it. FIG. 7 is a process flow for accessing the secured document 1c.

In FIG. 7, first, the user 9 inputs user authentication information (for example, the user name, the user password, and so on) and the secured document 1c in the user terminal 1, and instructs to display or print the secured document 1c (S71).

A document displaying/printing program 1p in the user terminal 1 sends the user authentication information to the user authentication server 10 (S72). A user authentication program 12 in the user authentication server 10 authenticates the user 9 based on the user authentication information by referring to information in a user management database 14, and sends the user authenticated result to the user terminal 1 (S73).

The document displaying/printing program 1p in the user terminal 1 obtains the document ID in the secured document 1c, and sends the obtained document ID, the user authenticated result received from the user authentication server 10, and the type of the access (displaying or printing) to the policy server A 20 (S74).

The policy server A program 22 in the policy server A 20 determines whether the user 9 accesses the secured document 1c and obligation of the user 9 by referring to the document security policy 21 and information in the document security attribute database 24 based on the document ID, the user authenticated result, and the type of the access. Then the policy server A program 22 sends the determined result of the access and the obligation to the user terminal 1, and further sends the decryption key when the user access is permitted (S75).

The document displaying/printing program 1p receives the determined result of the access and the obligation, and further receives the decryption key from the policy server A program 22 when the user access is permitted.

When the user access is not permitted, the document displaying/printing program 1p informs the user of the non-permission of the access, and the process flow ends.

When the user access is permitted, the document displaying/printing program 1p obtains the original document 1b by decrypting the encrypted document in the secured document 1c while using the received decryption key, and applies rendering to the original document 1b and displays the original document 1b (S76), or prints the original document 1b (S77). When the document displaying/printing program 1p receives an obligation (described below) from the policy server A program 22, a process for the obligation is executed. When the type of the access is to display, the original document 1b (the decrypted secured document 1c) is displayed on the user terminal 1, and when the type of the access is to print, the original document 1b is printed by the printer 2 by instructing the printer 2 to print the original document 1b.

The process flow by the document displaying/printing program 1p can use a process flow described in Patent Document 2. Therefore, when the process flow described in Patent Document 2 is used, a secret document is printed by the document security policy 21 and the policy server A program 22 while setting an obligation (requirement in Patent Document 2) such as “print by merging a traceable pattern on the background”.

In this case, when the user 9 requests to print the secured document 1c on the user terminal 1, the policy server A program 20 sends an obligation that the secured document 1c be printed by merging a traceable pattern as the determined result, and the document displaying/printing program 1p prints the secured document 1c by merging the traceable pattern on the printer 2.

Therefore, when the secured document 1c is copied, scanned, or transmitted by the facsimile function in the digital multifunctional apparatus 3, the secured document 1c can be recognized as a secret document.

In all cases of copying, scanning, and transmitting by a facsimile function the paper manuscript 3a in the digital multifunctional apparatus 3, the paper manuscript 3a is scanned, then the scanned image data are copied, stored, or transmitted by the facsimile function. The difference among the above processes occurs after scanning the paper manuscript 3a. Therefore, in the following, only the case of scanning the paper manuscript 3a is described. When copying or transmitting the paper manuscript 3a is executed, a process similar to the process in scanning the paper manuscript 3a is executed.

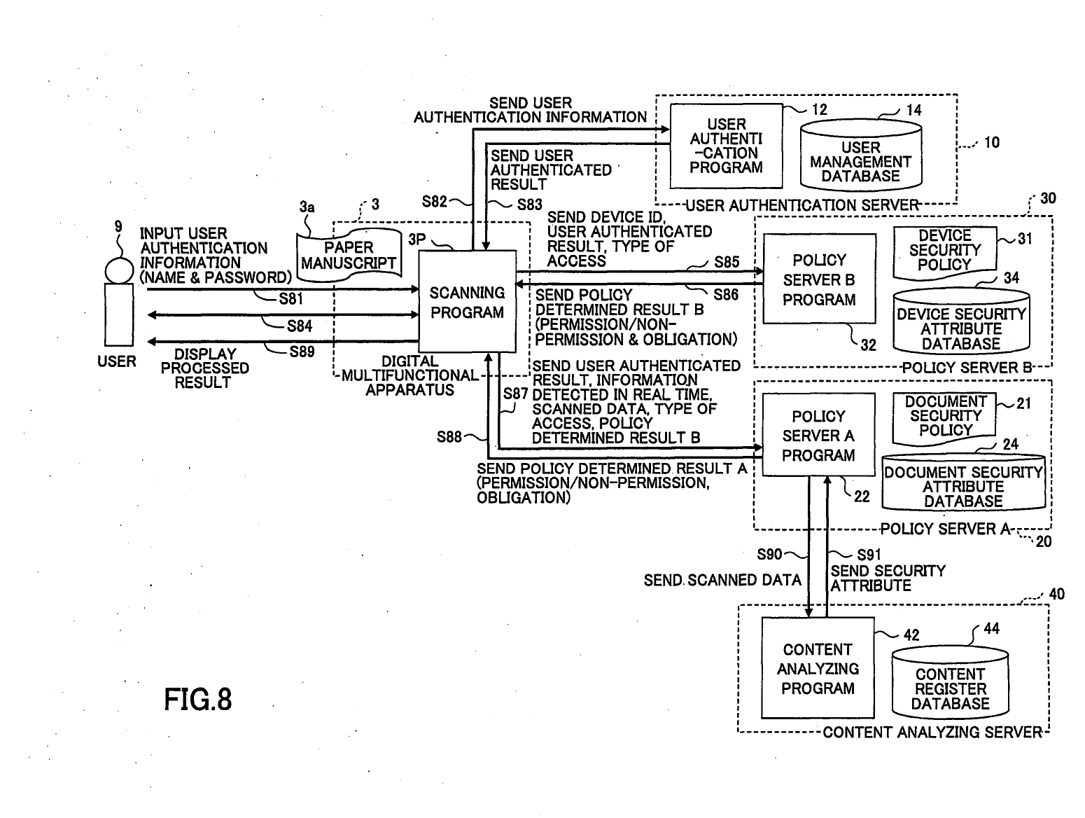

FIG. 8 is a process flow for scanning the paper manuscript 3a. As shown in FIG. 8, the policy server B 30 includes the device security policy 31, a policy server B program 32, and a device security attribute database 34.

In FIG. 8, when a user 9 desires to scan a paper manuscript 3a in the digital multifunctional apparatus 3, the user 9 inputs the user authentication information (the user name and the user password) on an operating panel of the digital multifunctional apparatus 3 (S81). A scanning program 3P in the digital multifunctional apparatus 3 sends the user authentication information received from the user 9 to the user authentication server 10 (S82).

The user authentication program 12 in the user authentication server 10 authenticates the user 9 based on the user authentication information by referring to information in the user management database 14, and sends the user authenticated result to the digital multifunctional apparatus 3 (S83).

When the user 9 is authenticated by the user authentication server 10, the scanning program 3P in the digital multifunctional apparatus 3 displays the user authenticated result on the operating panel (S84) and the user 9 pushes a scanning button in the digital multifunctional apparatus 3.

The scanning program 3P in the digital multifunctional apparatus 3 sends the user authenticated result, the ID (device ID) of the digital multifunctional apparatus 3, and the type of the access (in this case, scanning) to the policy server B 30, and the policy server B program 32 determines whether the user 9 has a right to scan the paper manuscript 3a in the digital multifunctional apparatus 3 by referring to the device security policy 31 and information in the device security attribute database 34 (S85).

The digital multifunctional apparatus 3 receives a policy determined result B including a permission/non-permission result and an obligation from the policy server B 30 (S86). When the policy determined result B shows permission, the digital multifunctional apparatus 3 scans the paper manuscript 3a. Then the scanning program 3P determines whether a specific background pattern is in the scanned image by analyzing image data of the scanned paper manuscript 3a.

The scanning program 3P sends the user authenticated result, information detected in real time including the type of the background pattern, the scanned data, the type of the access (scanning), and the policy determined result B to the policy server A 20. The policy server A program 22 determines whether that the user 9 has a right to scan the paper manuscript 3a (S87).

The digital multifunctional apparatus 3 receives a policy determined result A including the permission/non-permission for scanning and an obligation from the policy server A program 22 (S88), and executes the scanning process. For example, the digital multifunctional apparatus 3 sends the scanned data to a designated destination.

When the policy is determined, the policy server A program 22 merges the obligation which is included in the policy determined result B corresponding to the device security policy 31 with the obligation which is included in the policy determined result A corresponding to the document security policy 21 by a merging rule set beforehand in the policy server A program 22.

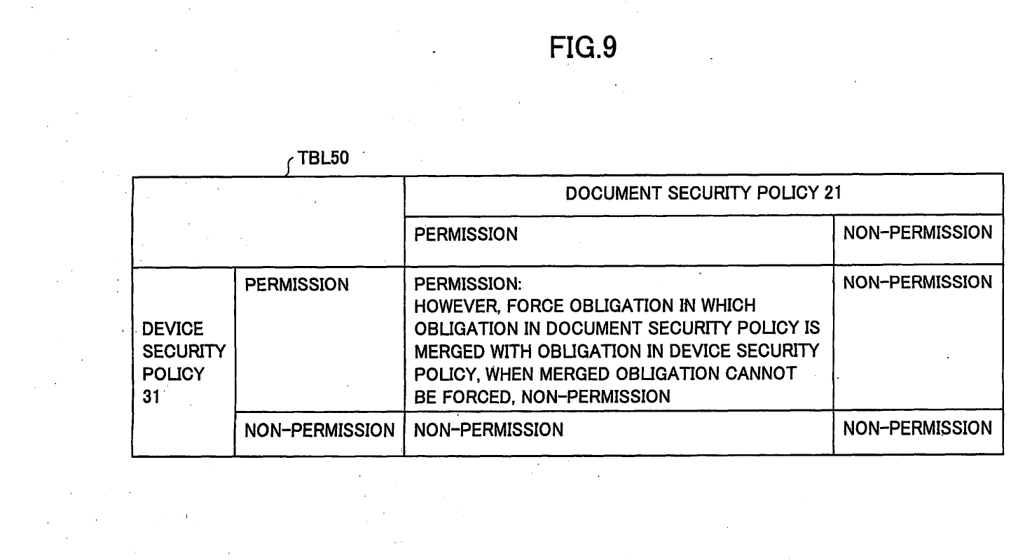

When the obligations cannot be merged, the policy determined result A is non-permission (described below in FIG. 9). When the policy determined result A is non-permission or the obligations of the policy determined results A and B cannot be executed, the scanning program 3P stops the scanning process as an error operation.

The scanning program 3P displays the above processed result on the user terminal 1 and ends the processes (S89).

The policy server A program 22 sends the scanned data received from the scanning program 3P to the content analyzing server 40 (S90). The content analyzing program 42 in the content analyzing server 40 estimates a security attribute by analyzing the background and the contents of the scanned data of the paper manuscript 3a. The policy server A program 22 receives the estimated security attribute (S91) and executes a process corresponding to the document security policy 21 based on the attribute. For example, the policy server A program 22 sends alert mail to the administrator terminal 4.

As described above, the scanning program 3P permits the user 9 to scan the paper manuscript 3a when the user 9 has both the right to use the digital multifunctional apparatus 3 and the right to use the paper manuscript 3a.

In addition, since the right determination is processed based on information obtained in real time, the scanning program 3P does not force the user 9 to wait unnecessarily. Further, since the contents of the scanned data are analyzed, even if a user 9 not having the right scans a secret document, the administrator can know about the unauthorized use of the secret document. Therefore, the document security system 100 can be realized in which the security of the secret document is maintained and usability is increased.

FIG. 9 is a table TBL 50 showing a rule of the permission and the non-permission for scanning the paper manuscript 3a by the user 9 in combinations of the document security policy 21 and the device security policy 31.

As shown in FIG. 9, only when the document security policy 21 and the device security policy 31 permit scanning the paper manuscript 3a by the user 9, the user 9 can scan the paper manuscript 3a. However, an obligation is forced on the permission in which the obligation of the document security policy 21 and the obligation of the device security policy 31 are merged by a predetermined rule. When the obligation cannot be forced, the scanning is not permitted.

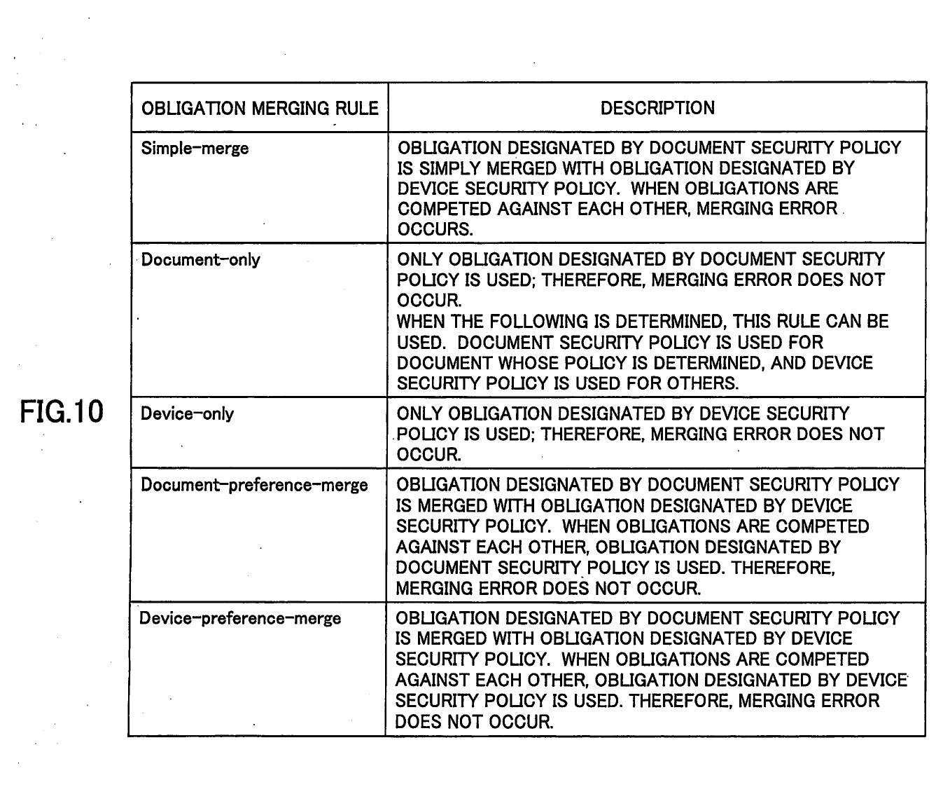

FIG. 10 is a table showing an example of obligation merging rules. In FIG. 10, in an obligation merging rule “Simple-merge”, an obligation designated by the document security policy 21 is simply merged with an obligation designated by the device security policy 31. When obligations which compete against each other exist, the merged result becomes a merging error.

In an obligation merging rule “Document-only”, only an obligation designated by the document security policy 21 is used. Therefore, a merging error does not occur. When the following is determined, this rule can be used. That is, the document security policy 21 is used for a document whose policy is determined, and device security policy 31 is used for others.

In an obligation merging rule “Device-only”, only an obligation designated by the device security policy 31 is used. Therefore, a merging error does not occur.

In an obligation merging rule “Document-preference-merge”, an obligation designated by the document security policy 21 is merged with an obligation designated by the device security policy 31. When obligations which compete against each other exist, the obligation designated by the document security policy 21 is used. Therefore, a merging error does not occur.

In an obligation merging rule “Device-preference-merge”, an obligation designated by the document security policy 21 is merged with an obligation designated by the device security policy 31. When obligations which compete against each other exist, an obligation designated by the device security policy 31 is used. Therefore, a merging error does not occur.

The administrator of the policy server A program 22 sets the obligation merging rule in the program 22 by selecting one of the obligation merging rules.

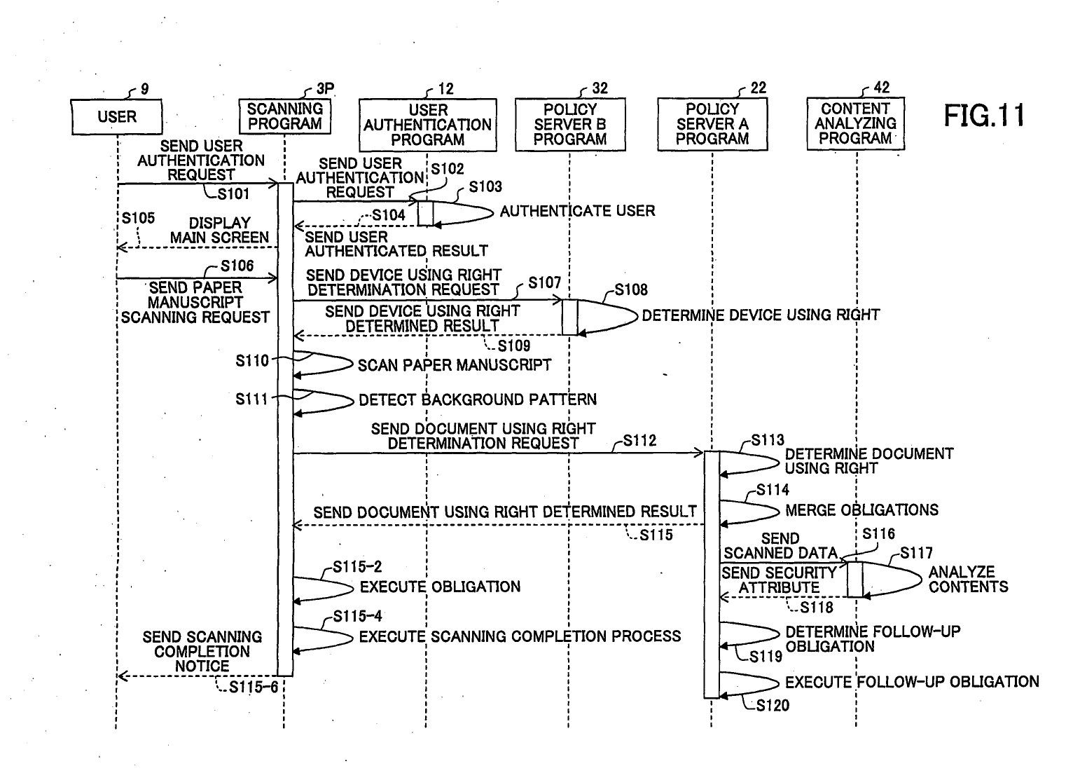

FIG. 11 is a sequence chart showing processes to scan the paper manuscript 3a. In FIG. 11, a request to a program is executed by a function call (continuous line), and a result processed by the function call is returned as a return value (dashed line).

Referring to FIG. 11, the processes are described. First, the user 9 requests to be authenticated by inputting user authentication information on the operating panel of the digital multifunctional apparatus 3 (S101). The scanning program 3P of the digital multifunctional apparatus 3 sends the request including the user authentication information to the user authentication server 10 (S102).

The user authentication program 12 in the user authentication server 10 authenticates the user 9 based on the user authentication information received from the digital multifunctional apparatus 3 (S103), and returns the user authenticated result to the scanning program 3P (S104).

When the user authenticated result shows successful, the scanning program 3P displays the main screen on the digital multifunctional apparatus 3 (S105). When the user authenticated result does not show successful, the scanning program 3P informs the user 9 of non-authentication and does not executes the processes by the user 9.

The user 9 sends a paper manuscript scanning request to the digital multifunctional apparatus 3 by putting the paper manuscript 3a thereon (S106). In order to determine whether the user 9 has a right to use the digital multifunctional apparatus 3, the scanning program 3P of the digital multifunctional apparatus 3 sends a device using right determination request to the policy server B 30 to determine whether the user 9 has the device using right based on the paper manuscript scanning request (S107). In the device using right determination request, the user authenticated result, the device information, and the type of access (in this case, scanning) are designated.

The policy server B program 32 in the policy server B 30 determines whether the user 9 has the device using right by referring to the device security policy 31 and information in the device security attribute database 34 (S108), and returns the determined result to the scanning program 3P as the device using right determined result (corresponding to the policy determined result B shown in FIG. 8) (S109).

When the user 9 does not have the device using right, the scanning program 3P informs the user 9 of that the user 9 does not have the device using right for scanning the paper manuscript 3a and ends the processes. When the user 9 has the device using right, the scanning program 3P scans the paper manuscript 3a (S110). Then the scanning program 3P detects a background pattern of the paper manuscript 3a from data scanned the paper manuscript 3a (S111).

In order to determine whether the user 9 has a document using right, the scanning program 3P sends a document using right determination request to the policy server A 20 (S112). The document using right determination request includes the user authenticated result, real time detected information by the background pattern detection in S111, the scanned data, the type of the access (in this case, scanning), the device using right determined result (corresponding to the policy determined result B shown in FIG. 8).

The policy server A program 22 in the policy server A 20 determines whether the user 9 has the document using right by referring to the document security policy 21 and information in the document security attribute database 24 (S113).

The policy server A program 22 in the policy server A 20 merges obligations designated by the document using right determined result and the device using right determined result by referring to the table TBL 50 shown in FIG. 9 and the obligation merging rule shown in FIG. 10 (S114).

The policy server A program 22 in the policy server A 20 sends the document using right determined result to the digital multifunctional apparatus 3 (S115).

Then the policy server A program 22 in the policy server A 20 sends the scanned data to the content analyzing server 40 (S116). The content analyzing program 42 in the content analyzing server 40 analyzes the contents of the scanned data (S117), and returns the analyzed result to the policy server A program 22 as a security attribute (S118).

Then the policy server A program 22 in the policy server A 20 determines whether an obligation exists based on the security attribute (S119), and executes the obligation based on the obligation determined result (S120). For example, alert mail is sent to the administrator terminal 4.

When the scanning program 3P receives the document using right determined result as a return value in S115 after sending the document using right determination request in S112, the scanning program 3P executes an obligation designated by the document using right determined result (S115-2) and executes a scanning completion process (S115-4).

The scanning program 3P sends a scanning completion notice to the user 9 as a return value for the request (S106) of scanning the paper manuscript 3a (S115-6). Then the digital multifunctional apparatus 3 displays the scanning completion on the operating panel and the user 9 recognizes the scanning completion.

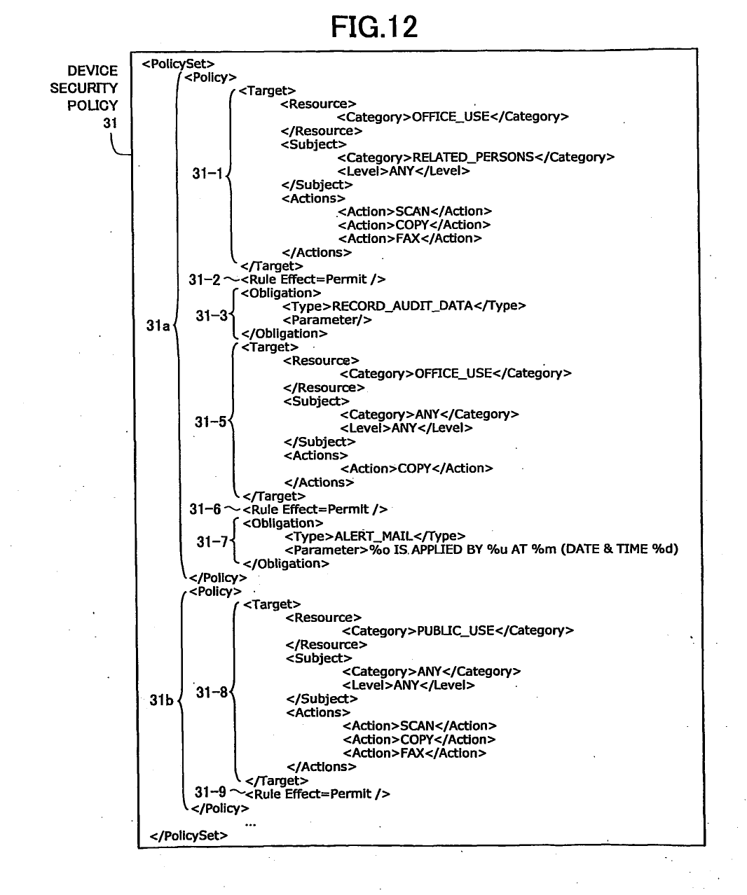

Next, referring to FIG. 12, a structure of the device security policy 31 is described. FIG. 12 is a diagram showing an example of the structure of the device security policy 31. In FIG. 12, the device security policy 31 is written, for example, in XML (extensible markup language) and is defined as a description between <PolicySet> and </PolicySet>.

In the device security policy 31 shown in FIG. 12, plural policies for a device to be used are defined in descriptions 31a, 31b, . . . between <Policy> and </Policy>.

Targets for a policy to be defined in the description 31a are defined as a description 31-1 from <Target> to </Target> through a description 31-5 from <Target> to </Target>. In the description 31-1, the targets are defined in the following. That is, the category (<Category>) of a resource (<Resource>) to be the target is “OFFICE_USE” for signifying that the device is used in an office. The category (<Category>) of persons (<Subject>) to be the target is “RELATED_PERSONS” for signifying related persons, and the level for signifying the right level of the related persons is “ANY” for signifying that the right level is not restricted. The functions (<Actions>) to be the targets are “SCAN” for signifying scanning, “COPY” for signifying copying, and “FAX” for signifying facsimile the document.

For the targets defined in the description 31-1, permission is defined by the description 31-2 of <Rule Effect=Permit/> signifying permission or non-permission.

In addition, by the obligation (<Obligation>) in the description 31-3, the type (<Type>) of the obligation signifying to record a log “RECORD_AUDIT_DATA” is designated.

As described above, the followings are defined in the description 31-5. That is, the category (<Category>) of a resource (<Resource>) to be the target is “OFFICE_USE” for signifying that the device is used in an office, the category (<Category>) of persons (<Subject>) to be the target is “ANY” for signifying the related persons are not restricted, and the level for signifying the right level of the related persons is “ANY” for signifying that the right level is not restricted, and the function (<Actions>) to be the target is “COPY” signifying for copying the document.

In addition, for the targets defined by the description 31-5, the permission is defined by the description 31-6 of <Rule Effect=Permit/> signifying permission or non-permission.

In addition, by an obligation (<Obligation>) in the description 31-7, the type (<Type>) of the obligation “ALERT_MAIL” signifying alert mail is designated. Further, a parameter for writing in the alert mail is defined as, for example, “% o is applied by % u at % m.(date and time % d)”. The parameter is described below in detail.

Targets for a policy to be defined in the description 31b are defined as a description 31-8 from <Target> to </Target>. In the description 31-8, the targets are defined in the following. That is, the category (<Category>) of a resource (<Resource>) to be the target is “PUBLIC_USE” for signifying that the device is used in public (no restriction). The category (<Category>) of persons (<Subject>) to be the target is “ANY” for signifying the persons are not restricted, and the level for signifying the right level of the persons is “ANY” for signifying that the right level is not restricted. The functions (<Actions>) to be the targets are “SCAN” for signifying scanning, “COPY” for signifying copying, and “FAX” for signifying facsimile the document.

For the targets defined in the description 31-8, permission is defined by the description 31-9 of <Rule Effect=Permit/> signifying permission or non-permission.

For the targets to be defined in the description 31-8, the obligation (<Obligation>) is not designated.

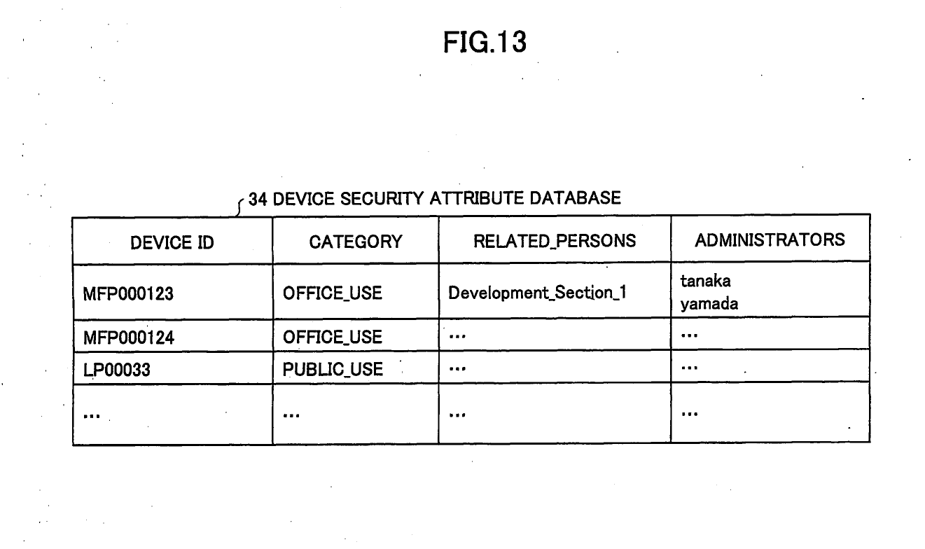

Next, referring to FIG. 13, a structure of the device security attribute database 34 is described. FIG. 13 is a diagram showing an example of the device security attribute database 34. As shown in FIG. 13, the structure of the device security attribute database 34 includes items of “DEVICE ID” (device identifying information) for identifying a device, “CATEGORY” for signifying a using range of the device, “RELATED_PERSONS” for signifying persons (sections) using the device, “ADMINISTRATORS” for signifying administrators of the device, and so on.

In the “DEVICE ID”, information for identifying devices, for example, MFP000123, MFP000124, LP00033, and so on are registered. In the “CATEGORY”, “OFFICE_USE” for signifying that the device can be used by only persons in the office, “PUBLIC_USE” for signifying that the device can be used by any persons in the office and in public, and so on are shown.

For example, in the MFP000123 of “DEVICE ID”, since the “CATEGORY” is “OFFICE_USE” and “RELATED_PERSONS” is “Development_Section_1”, the users are restricted to the persons in the development section 1. In addition, the administrators of the MFP000123 are “tanaka” and “yamada”.

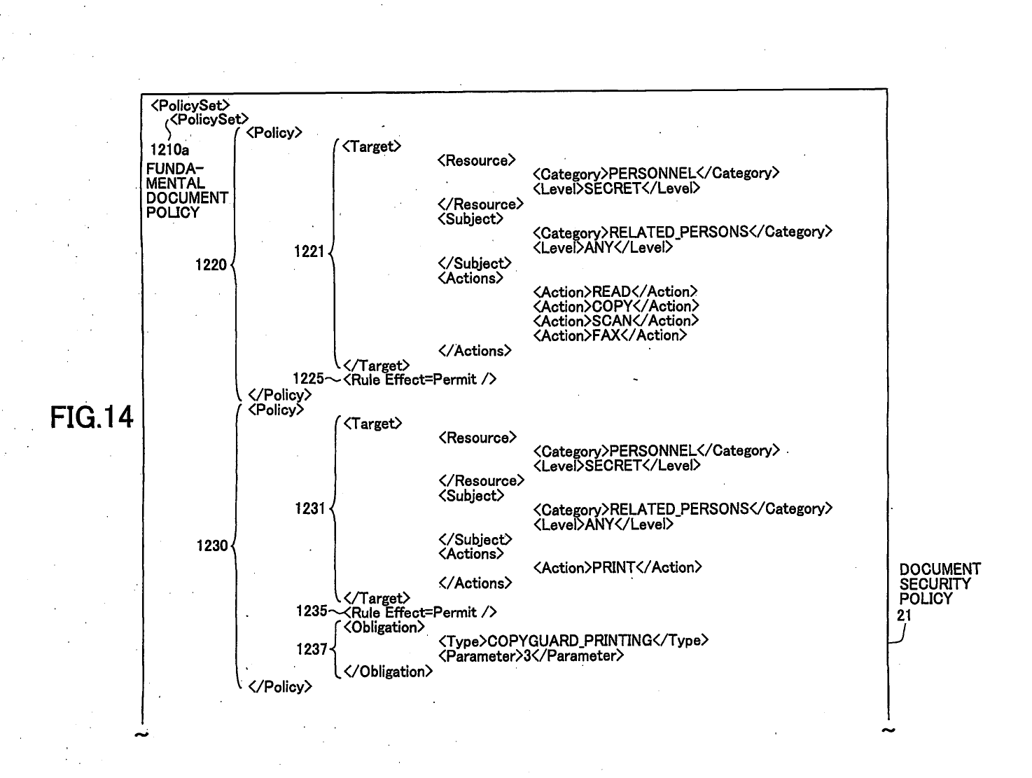

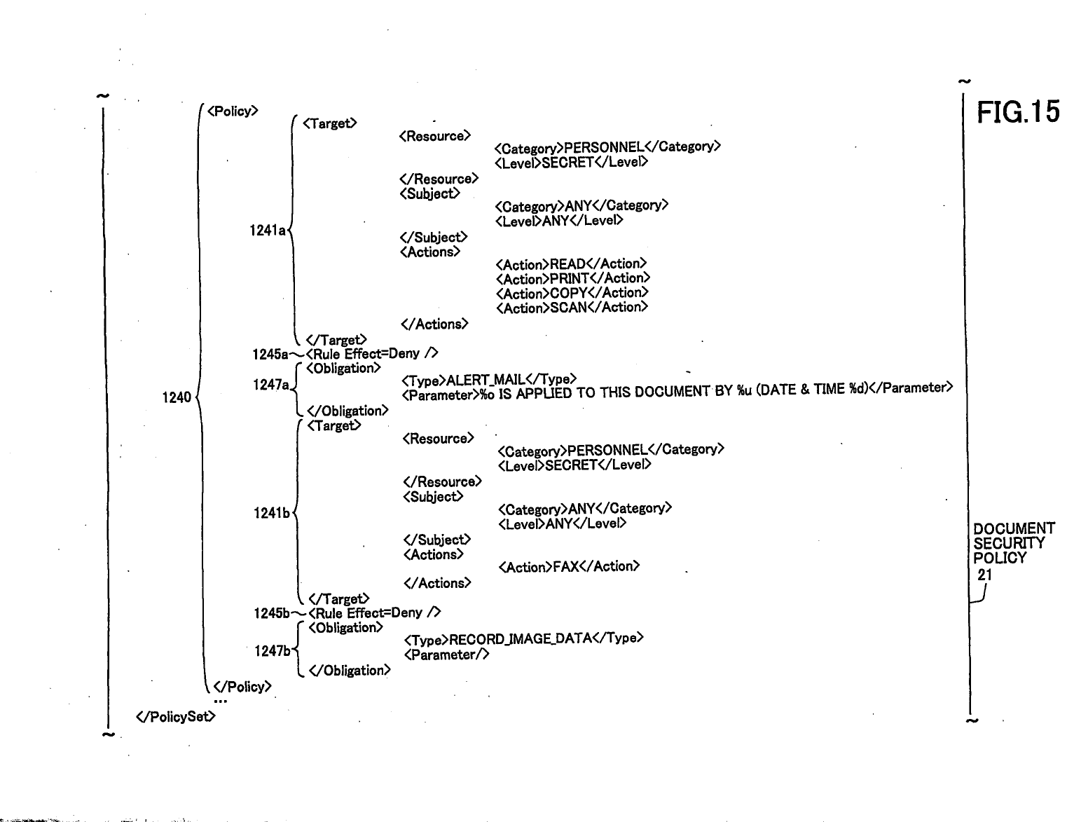

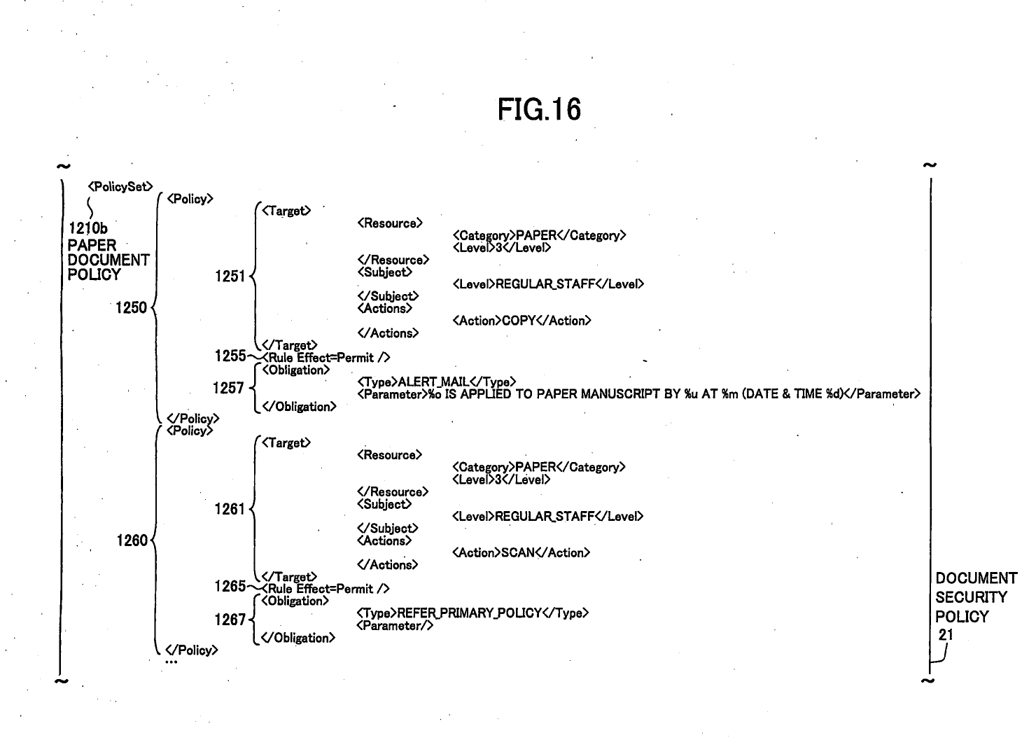

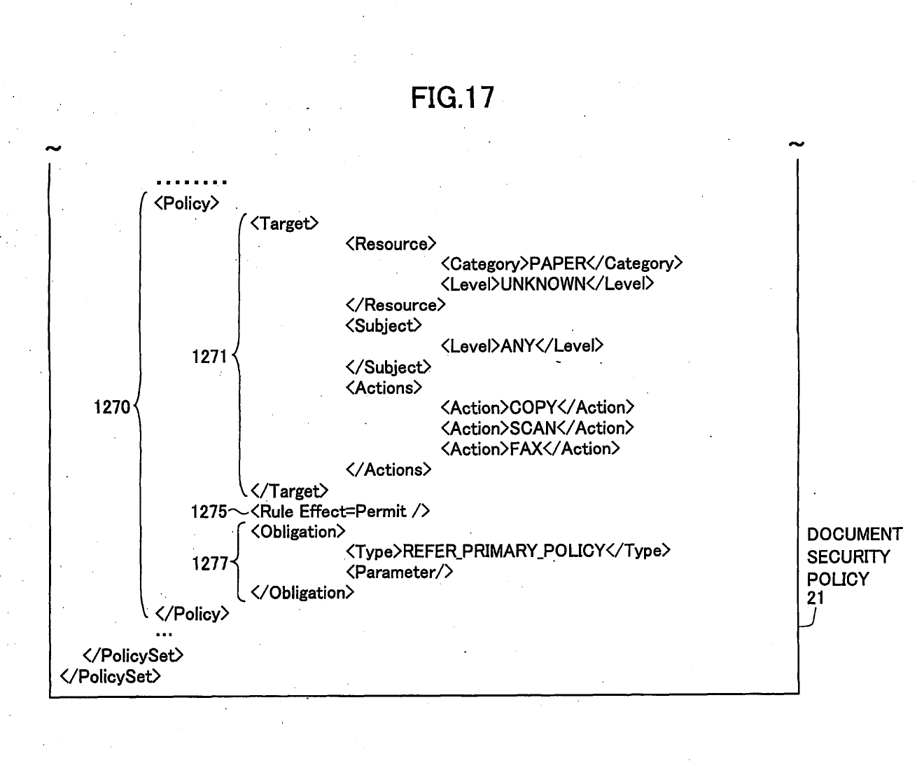

Next referring to FIGS. 14 through 17, a structure of the document security policy 21 is described. FIG. 14 is a diagram showing a first part of the structure of the document security policy 21. FIG. 15 is a diagram showing a second part of the structure of the document security policy 21. FIG. 16 is a diagram showing a third part of the structure of the document security policy 21. FIG. 17 is a diagram showing a fourth part of the structure of the document security policy 21. The structure is a data file of the document security policy 21. In FIGS. 14 through 17, the document security policy 21 is written, for example, in XML and is defined as a description between <PolicySet> and </PolicySet>.

In the document security policy 21 shown in FIGS. 14 through 17, plural policies are defined by descriptions between <PolicySet> and </PolicySet> for documents to be used, for example, a paper document, an electronic document, and so on. In addition, the plural policies are defined by classifying into corresponding policies by using the description between <PolicySet> and </PolicySet>.

In the document security policy 21 shown in FIGS. 14 through 17, the plural policies are defined in the descriptions 1220 through 1270 between <PolicySet> and </PolicySet> for devices to be used. The descriptions 1220 through 1240 are classified into a fundamental document policy 1210a to be described between <PolicySet> and </PolicySet>, and the descriptions 1250 through 1270 are classified into a fundamental document policy 1210b to be described between <PolicySet> and </PolicySet>.

First, a policy to be defined by the fundamental document policy 1210a is described.

Targets of a policy to be defined in the description 1220 are defined as a description 1221 from <Target> to </Target>. In the description 1221, the targets are defined in the following. That is, the category (<Category>) of a resource (<Resource>) to be the target is “PERSONNEL” for signifying that the document is related to a personnel section, and the secret level of the document is “SECRET” for signifying confidential. The category (<Category>) of persons (<Subject>) to be the target is “RELATED_PERSONS” for signifying the related persons, and the level for signifying the right level of the related persons is “ANY” for signifying that the right level is not restricted. The functions (<Actions>) to be the targets are “READ” for signifying reading, “SCAN” for signifying scanning, “COPY” for signifying copying, and “FAX” for signifying facsimile the document.

For the targets defined in the description 1221, permission is defined by the description 1225 of <Rule Effect=Permit/> signifying permission or non-permission.

In addition, for the targets to be defined in the description 1221, an obligation (<Obligation>) is not designated.

Targets of a policy to be defined in the description 1230 are defined as a description 1231 from <Target> to </Target>. In the description 1231, the targets are defined in the following. That is, the category (<Category>) of a resource (<Resource>) to be the target is “PERSONNEL” for signifying that the document is related to a personnel section, and the secret level of the document is “SECRET” for signifying confidential. The category (<Category>) of persons (<Subject>) to be the target is “RELATED_PERSONS” for signifying the related persons, and the level for signifying the right level of the related persons is “ANY” for signifying that the right level is not restricted. The function (<Actions>) to be the targets is “PRINT” for signifying printing the document.

For the targets defined in the description 1231, permission is defined by the description 1235 of <Rule Effect=Permit/> signifying permission or non-permission.

In addition, as an obligation (<Obligation>) by a description 1237, in order to prevent an unauthorized copy of the document, the type (<Type>) of the obligation “COPYGUARD_PRINTING” is designated. Further, a copy protection for preventing an unauthorized copy is specified by a parameter.

In FIG. 15, targets of a policy to be defined in the description 1240 are defined as a description 1241a from <Target> to </Target>. In the description 1241a, the targets are defined in the following. That is, the category (<Category>) of a resource (<Resource>) to be the target is “PERSONNEL” for signifying that the document is related to a personnel section, and the secret level of the document is “SECRET” for signifying confidential. The category (<Category>) of persons (<Subject>) to be the target is “ANY” for signifying that any persons are not restricted, and the level for signifying the right level of the persons is “ANY” for signifying that the right level is not restricted. The functions (<Actions>) to be the targets are “READ” for signifying reading, “PRINT” for signifying printing, “COPY” for signifying copying, and “SCAN” for signifying scanning the document.

For the targets defined in the description 1241a, non-permission is defined by the description 1245a of <Rule Effect=Deny/> signifying permission or non-permission.

In addition, as an obligation (<Obligation>) by a description 1247a, the type (<Type>) of the obligation of “ALERT_MAIL” for signifying alert mail is designated. Further, a parameter for writing in the alert mail is designated as, for example, “% o is applied to this document by % u (date and time % d)”.

Targets of a policy to be defined in a description 1241b are defined from <Target> to </Target>. In the description 1241b, the targets are defined in the following. That is, the category (<Category>) of a resource (<Resource>) to be the target is “PERSONNEL” for signifying that the document is related to a personnel section, and the secret level of the document is “SECRET” for signifying confidential. The category (<Category>) of persons (<Subject>) to be the target is “ANY” for signifying that any persons are not restricted, and the level for signifying the right level of the persons is “ANY” for signifying that the right level is not restricted. The function (<Actions>) to be the targets is “FAX” for signifying to facsimile the document.

For the targets defined in the description 1241b, non-permission is defined by the description 1245b of <Rule Effect=Deny/> signifying permission or non-permission.

In addition, as an obligation (<Obligation>) by a description 1247b, the type (<Type>) of the obligation “RECORD_IMAGE_DATA” for signifying that image data to be facsimiled are recorded is designated. In this case, a parameter is not designated.

Next, in FIG. 16, policies to be defined in a paper document policy 1210b are described.

Targets of a policy to be defined in the description 1250 are defined as a description 1251 from <Target> to </Target>. In the description 1251, the targets are defined in the following. That is, the category (<Category>) of a resource (<Resource>) to be the target is “PAPER” for signifying that the document is a paper document, and the secret level of the paper document is “3”. The right level (<Level>) of persons (<Subject>) to be the target is “REGULAR_STAFF” for signifying that the persons are full-time regular staffs. The function (<Actions>) to be the targets is “COPY” for signifying copying the paper document.

For the targets to be defined in the description 1251, permission is defined by the description 1255 of <Rule Effect=Permit/> signifying permission or non-permission.

In addition, as an obligation (<Obligation>) by a description 1257, the type (<Type>) of the obligation of “ALERT_MAIL” for signifying alert mail is designated. Further, a parameter for writing in the alert mail is designated as, for example, “% o is applied to paper document by % u at % m (date and time % d)”.

Targets of a policy to be defined in the description 1260 are defined as a description 1261 from <Target> to </Target>. In the description 1261, the targets are defined in the following. That is, the category (<Category>) of a resource (<Resource>) to be the target is “PAPER” for signifying that the document is a paper document, and the secret level of the paper document is “3”. The right level (<Level>) of persons (<Subject>) to be the target is “REGULAR_STAFF” for signifying that the persons are full-time regular staffs. The function (<Actions>) to be the targets is “SCAN” for signifying scanning the paper document.

For the targets to be defined in the description 1261, permission is defined by the description 1265 of <Rule Effect=Permit/> signifying permission or non-permission.

In addition, as an obligation (<Obligation>) by a description 1267, the type (<Type>) of the obligation of “REFER_PRIMARY_POLICY” for signifying that the document policy is obliged by image analysis is designated. In this case, a parameter is not designated.

In FIG. 17, targets of a policy to be defined in the description 1270 are defined as a description 1271 from <Target> to </Target>. In the description 1271, the targets are defined in the following. That is, the category (<Category>) of a resource (<Resource>) to be the target is “PAPER” for signifying that the document is a paper document, and the secret level of the paper document is “UNKNOWN”. The right level (<Level>) of persons (<Subject>) to be the target is “ANY” for signifying that the right levels of the persons are not restricted. The functions (<Actions>) to be the targets are “COPY” for signifying copying, “SCAN” for signifying scanning, and “FAX” for signifying facsimile the paper document.

For the targets to be defined in the description 1271, permission is defined by the description 1275 of <Rule Effect=Permit/> signifying permission or non-permission.

In addition, as an obligation (<Obligation>) by a description 1277, the type (<Type>) of the obligation of “REFER_PRIMARY_POLICY” for signifying that the document policy is obliged by image analysis is designated. In this case, a parameter is not designated.

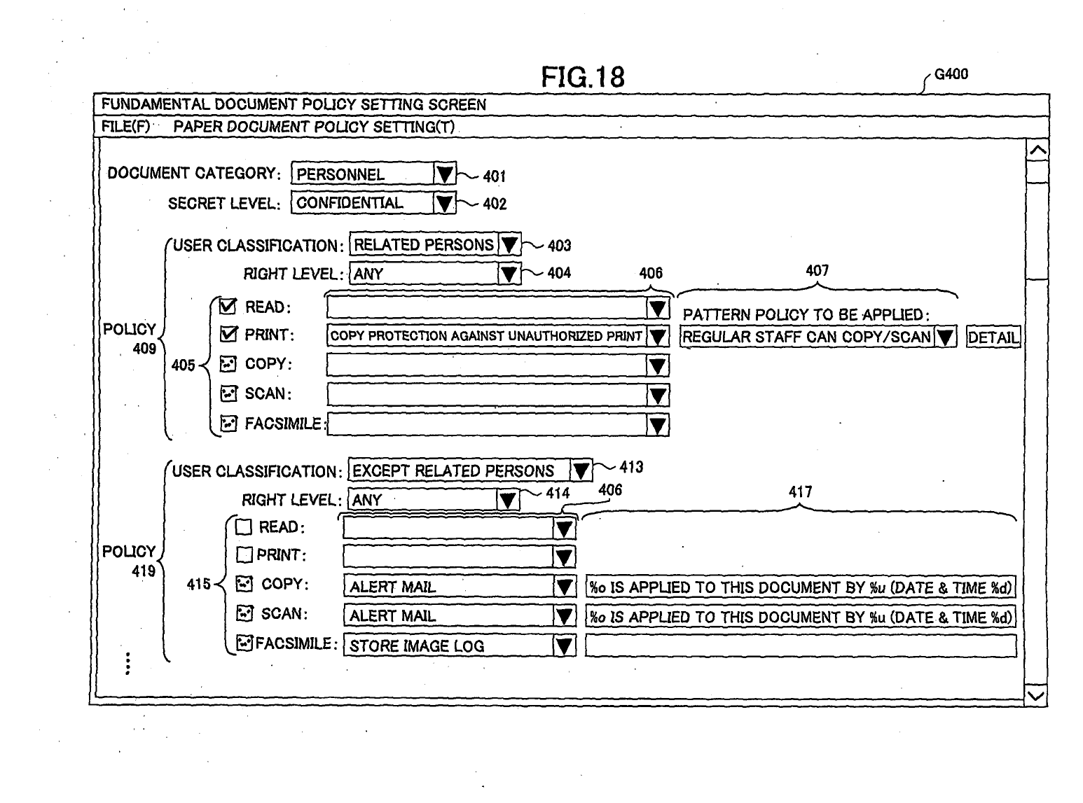

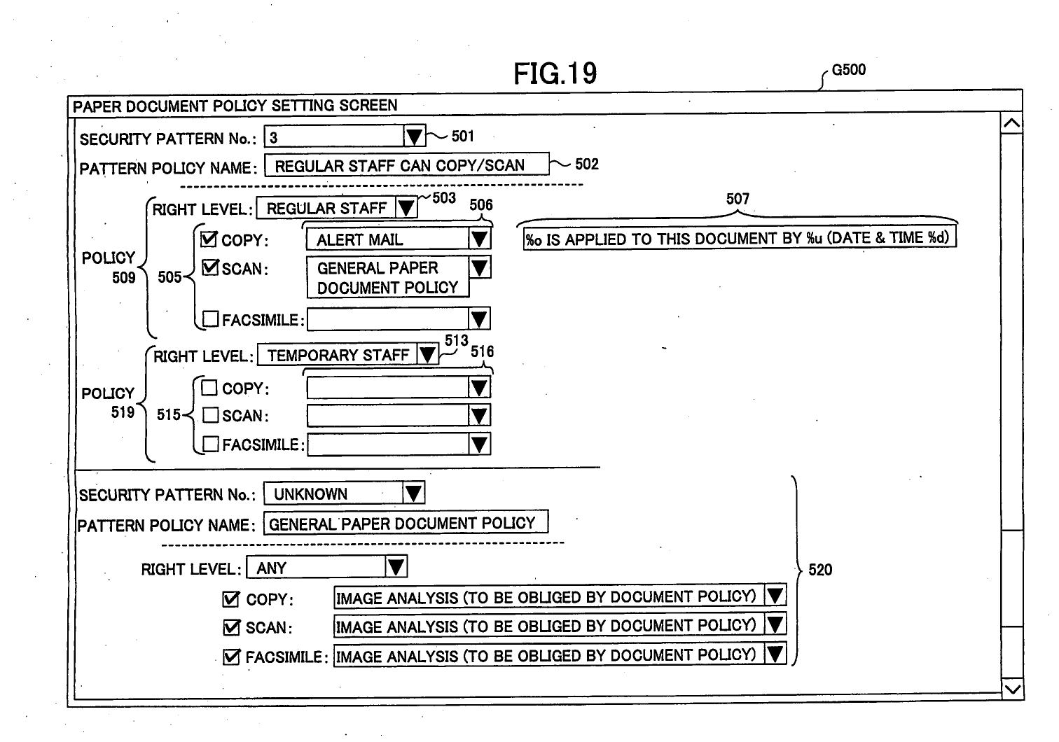

Next, referring to FIGS. 18 and 19, a setting method of the document policy is described. FIG. 18 is a diagram showing an example of a screen for setting a fundamental document policy. In a fundamental document policy setting screen G400, for example, as the document category, “PERSONNEL” is set in a setting region 401, and as the secret level, “CONFIDENTIAL” is set in a setting region 402.

In addition, plural policies 409, 419, . . . are set by combinations of a user classification and a right level for documents of “PERSONNEL” and “CONFIDENTIAL”.

In the policy 409, as the user classification, “RELATED PERSONS” is set in a setting region 403, and as the right level, “ANY” is set in a setting region 404.

In a selection region 405 of the policy 409, “READ” and “PRINT” are set by an administrator, and since “COPY”, “SCAN”, and “FACSIMILE” are not set in real rime by the administrator, those are set beforehand.

In a setting region 406, an obligation is set corresponding to each in the selection region 405. For example, in the setting region 406 corresponding to “PRINT”, as the obligation, “COPY PROTECTION AGAINST UNAUTHORIZED COPY” is set.

In addition, in a setting region 407, a pattern policy to be applied is set. For example, “REGULAR STAFF CAN COPY/SCAN” is set. With this, the pattern policy is specified for “COPY PROTECTION AGAINST UNAUTHORIZED COPY” in “PRINT” of the selection region 405. “REGULAR STAFF CAN COPY/SCAN” relates to “3” in a security pattern No. described in FIG. 19.

In the policy 419, as the user classification in a setting region 413, “EXCEPT RELATED PERSONS” is set, and as the right level in setting region 414, “ANY” is set.

Similar to the policy 409, in the policy 419, since “COPY”, “SCAN”, and “FACSIMILE” are not controlled in real rime by the administrator, those are set beforehand in a selection region 415.

In a setting region 416, an obligation is set corresponding to each in the selection region 415. For example, in the setting region 416 corresponding to “COPY” and “SCAN”, as the obligation, “ALERT MAIL” is set; and in the setting region 416 corresponding to “FACSIMILE”, as the obligation, “STORE IMAGE LOG” is set.

In addition, in a setting region 417, a pattern policy to be applied is set. For example, as the contents to be written in the alert mail (corresponds to a parameter of an obligation), “% o is applied to this document by % u (data and time % d)” is displayed. For the % o, a function name is substituted, for the % u, a user name is substituted, and for the % d, the date and time are substituted.

FIG. 19 is a diagram showing an example of a screen for setting a policy for a paper document. In a paper document policy setting screen G500, for example, as the security pattern No., “3” is set in a setting region 501, and as a pattern policy name, “ONLY REGULAR PERSONS CAN COPY/SCAN” is set in a setting region 502.

In addition, plural policies 509, 519, . . . are set corresponding to the right levels for the security pattern No. “3”.

In the policy 509, as the right level, for example, “REGULAR STAFFS” is set in a setting region 503.

In a selection region 505 of the policy 509, “COPY” and “SCAN” are set by an administrator.

In a setting region 506, an obligation is set corresponding to each in the selection region 505. For example, in the setting region 506 corresponding to “COPY”, as the obligation, “ALERT MAIL” is set, and in the setting region 506 corresponding to “SCAN”, as the obligation, “IMAGE ANALYSIS (to be obliged by document policy)” is set.

In addition, in a setting region 507 corresponding to “COPY”, as the contents to be written in the alert mail (corresponds to a parameter of an obligation), “% o is applied to this document by % u (data and time % d)” is displayed. For the % o, a function name is substituted, for the % u, a user name is substituted, and for the % d, the date and time are substituted.

In addition, in a policy 519, for example, as the right level, when “TEMPORARY STAFF” is set in a setting region 513, in a selection region 515 and a setting region 516, nothing is set.

Similar to in the policies 509 and 519, in a policy 520, settings are executed.

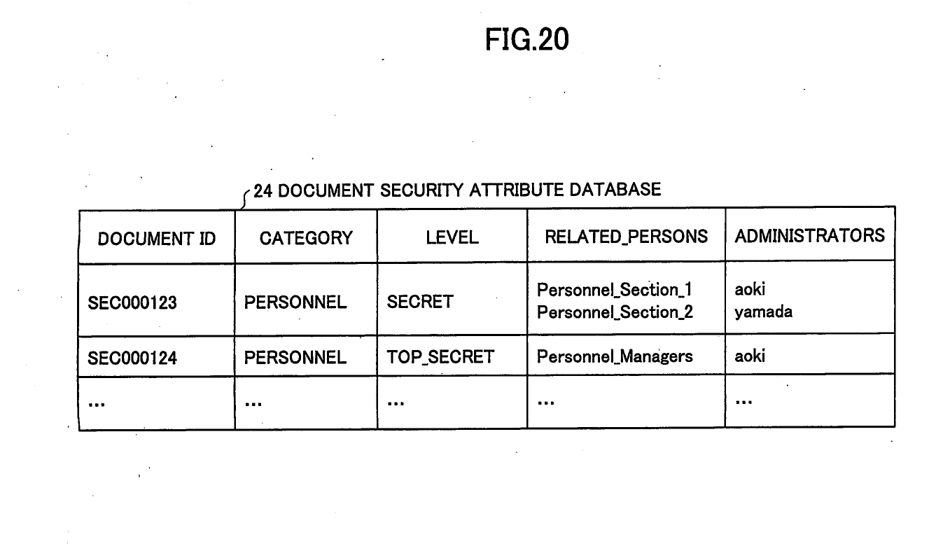

Next, referring to FIG. 20, a structure of the document security attribute database 24 is described. FIG. 20 is a diagram showing an example of the structure of the document security attribute database 24. As shown in FIG. 20, the structure of the document security attribute database 24 includes items of “DOCUMENT ID” (document identifying information) for identifying a document, “CATEGORY” for signifying a using range of the document, “LEVEL” for signifying a secret level of the document, “RELATED_PERSONS” for signifying persons (sections) using the document, “ADMINISTRATORS” for signifying administrators of the document, and so on.

In the “DOCUMENT ID”, information for identifying documents, for example, SEC000123, SEC000124, and so on are registered. In the “CATEGORY”, for example, “PERSONNEL” for signifying a personnel section is set. In the “LEVEL”, for example, “SECRET” for signifying confidential and “TOP_SECRET” for signifying a top secret are set. In the “RELATED_PERSONS”, sections such as “Personnel_Section_1”, “Personnel_Section₂”, “Personnel Managers” are set. In the “ADMINISTRATORS”, the names of the administrators, for example, “aoki” and “yamada” are set.

For example, in a document identified by “SEC000123” in “DOCUMENT ID”, since the “CATEGORY” is “PERSONNEL” and “LEVEL” is “SECRET”, “RELATED_PERSONS” is restricted to persons in “Personnel_Section_1” and “Personnel_Section 2”. In addition, the administrators of the document identified by “SEC000123” are “aoki” and “yamada”.

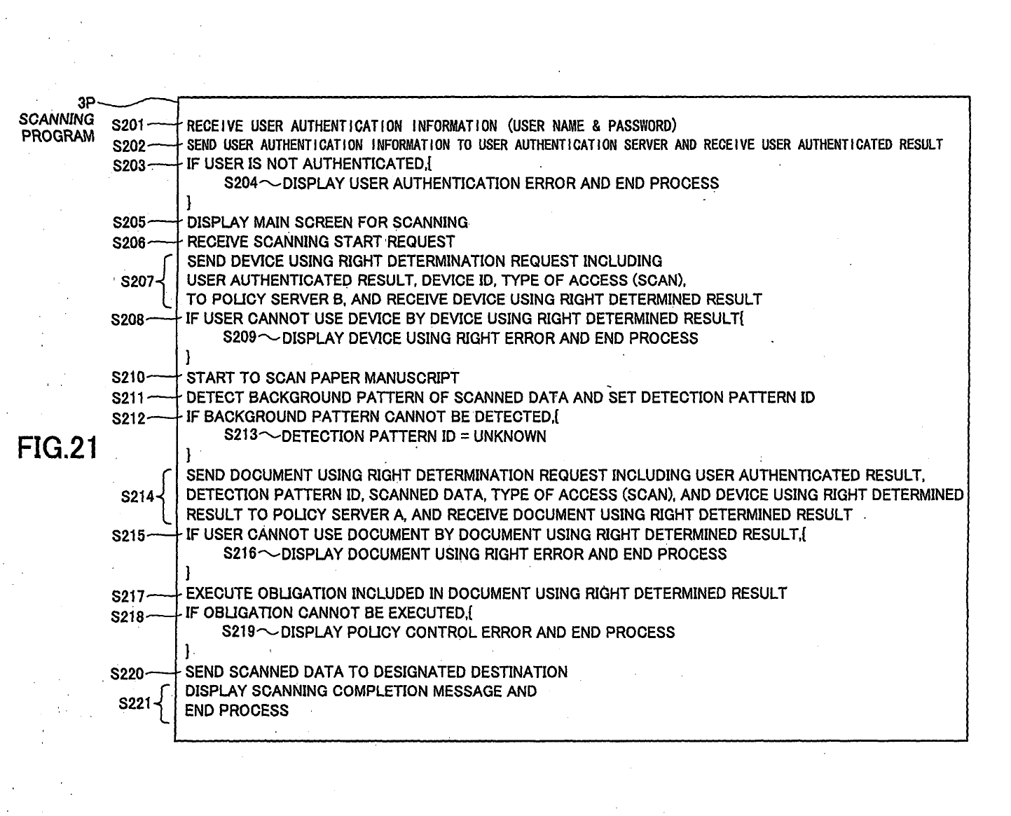

Next, referring to FIG. 21, processes to be executed by the scanning program 3P are described. FIG. 21 is a diagram showing the processes to be executed by the scanning program 3P.

First, the scanning program 3P receives user authentication information (user name and user password) from a user 9 (S201).

Then the scanning program 3P sends the user authentication information to the user authentication server 10 and receives a user authenticated result from the user authentication server 10 (S202), and determines whether the user 9 is authenticated (S203). When the user 9 is not authenticated, the scanning program 3P displays a user authentication error on an operating panel of the digital multifunctional apparatus 3 and ends the processes (S204).

When the user 9 is authenticated, the scanning program 3P displays a main screen for scanning on the operating panel of the digital multifunctional apparatus 3 (S205). When the scanning program 3P receives a scanning start request from the user 9 (S206), the scanning program 3P sends a device using right determination request; which includes the user authenticated result, the device ID (ID No. of the digital multifunctional apparatus 3), the type of access (scanning); to the policy server B 30, and receives a device using right determined result from the policy server B 30 (S207).

The scanning program 3P determines whether the device using right determined result shows successful (S208). When the device using right determined result does not show successful, the scanning program 3P displays a device using right error on the operating panel of the digital multifunctional apparatus 3 and ends the processes (S209).

When the device using right determined result shows successful, the scanning program 3P starts to scan the paper manuscript 3a (S210). Then the scanning program 3P detects a background pattern of scanned data generated by scanning the paper manuscript 3a and sets the background pattern as a detection pattern ID (S211). When the scanning program 3P cannot detect the background pattern (S212), the scanning program 3P sets “UNKNOWN” in the detection pattern ID (S213).

After setting that the background pattern is the detection pattern ID, the scanning program 3P sends a document using right determination request, which includes the user authenticated result, the detection pattern ID, the scanned data, the type of access (scanning), and the device using right determined result, to the policy server A 20 and receives a document using right determined result from the policy server A 20 (S214).

Then the scanning program 3P determines whether the document using right determined result shows successful (S215). When the document using right determined result does not show successful, the scanning program 3P displays a document using right error on the operating panel of the digital multifunctional apparatus 3 and ends the processes (S216).

When the document using right determined result shows successful, the scanning program 3P executes an obligation which is included in the document using right determined result (S217). The scanning program 3P determines whether the obligation is executed (S218). When the obligation cannot be executed, the scanning program 3P displays a policy control error on the operating panel of the digital multifunctional apparatus 3 and ends the processes (S219).

When the obligation can be executed, the scanning program 3P outputs the scanned data to a designated destination (S220). Then the scanning program 3P displays a scanning completion message on the operating panel of the digital multifunctional apparatus 3 and ends the processes (S221).

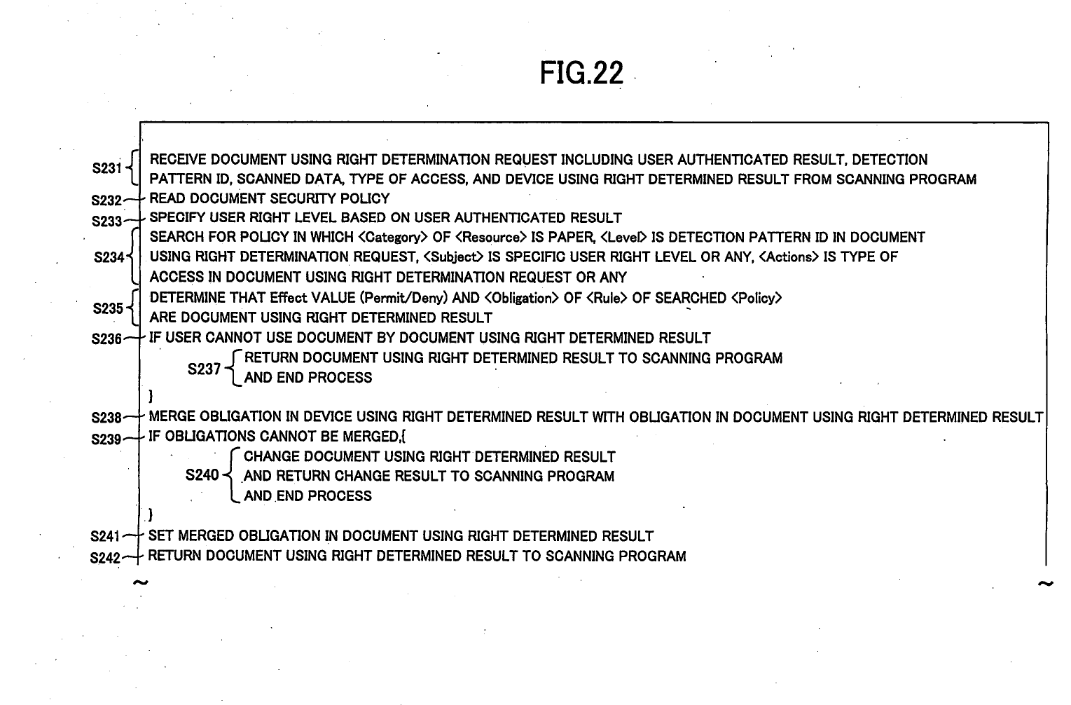

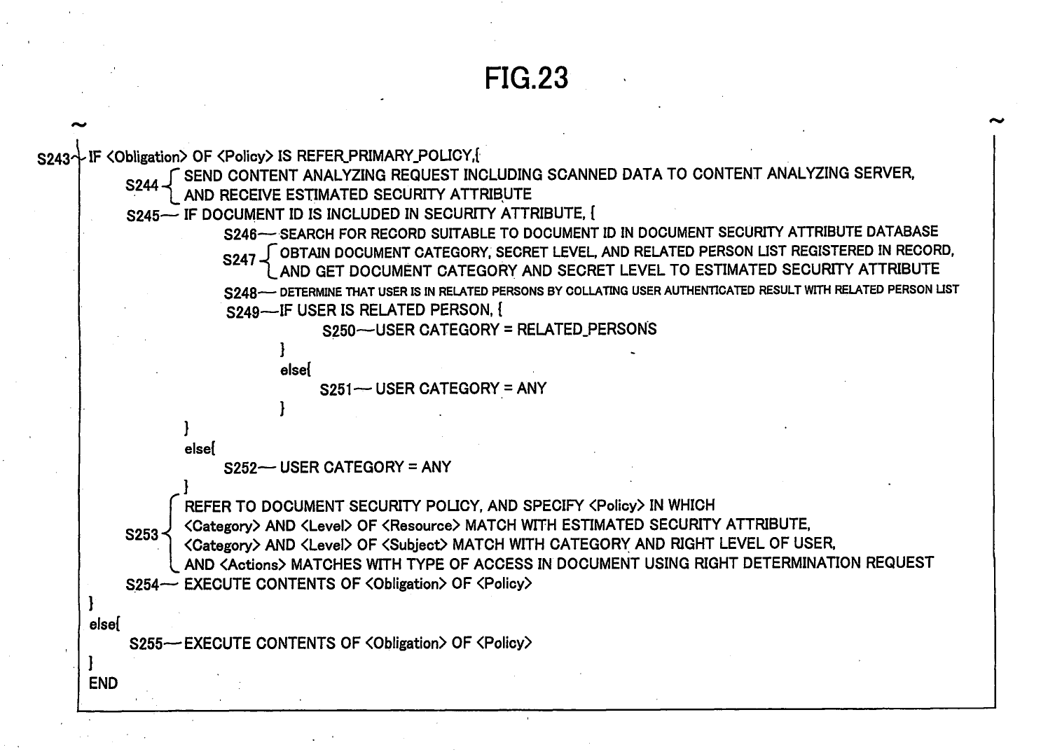

Next, referring to FIGS. 22 and 23, processes to be executed by the policy server A 20 are described. FIG. 22 is a diagram showing processes to be executed by the policy server A 20. FIG. 23 is a diagram showing processes to be executed after the processes shown in FIG. 22 by the policy server A 20. That is, the processes shown in FIGS. 22 and 23 are continuously executed.

In FIG. 22, first, the policy server A 20 receives a document using right determination request, which includes the user authenticated result, the detection pattern ID, the scanned data, the type of access, the device using right determined result, from the scanning program 3P of the digital multifunctional apparatus 3 (S231).

The policy server A program 22 of the policy server A 20 reads a document security policy 21 (S232), and specifies the right level of the user 9 based on the user authenticated result (S233).

The policy server A program 22 searches for <Policy> in which <Category> of <Resource> is “PAPER” (paper manuscript), <Level> is the detection pattern ID in the document using right determination request, <Level> of <Subject> is a specific user right level or “ANY”, and <Actions> is the type of the access in the document using right determination request or “ANY” (S234).

Then the policy server A program 22 determines that a searched Effect value (Permit/Deny) in <Rule> of <Policy> and <Obligation> are a document using right determined result (S235). The policy server A 20 determines whether the document using right determined result shows permission (S236). When the document using right determined result does not show permission, the policy server A 20 sends the document using right determined result to the scanning program 3P and ends the processes (S237).

When the document using right determined result shows permission, the policy server A program 22 merges the obligation in the device using right determined result with the obligation in the document using right determined result (S238).

Next, the policy server A program 22 determines whether the obligations are merged (S239). When the obligations cannot be merged, the policy server A program 22 changes the document using right determined result to non-permission, sends the changed document using right determined result to the scanning program 3P, and ends the processes (S240).

When the obligations are merged, the policy server A program 22 sets the merged obligation in the obligation of the document using right determined result (S241). Then the policy server A program 22 sends the document using right determined result to the scanning program 3P (S242).

In FIG. 23, the policy server A program 22 determines whether <Obligation> in <Policy> searched in S235 is “REFER_PRIMARY_POLICY” (S243). When <Obligation> in <Policy> searched in S235 is “REFER_PRIMARY_POLICY”, the policy server A 20 sends a content analyzing request including the scanned data to the content analyzing server 40 and receives an estimated security attribute (S244).

The policy server A program 22 determines whether a document ID is included in the received security attribute (S245). When the document ID is included in the received security attribute, the policy server A program 22 searches for a record suitable to the document ID in the document security attribute database 24 (S246). Then the policy server A program 22 obtains the document category, the secret level, and the list of the related persons registered in the record; and sets the document category and the secret level in the security attribute (S247).

The policy server A program 22 collates the user authenticated result with the list of the related persons and determines whether the user 9 is in the list of the related persons (S248). When the user 9 is in the list of the related persons, the policy server A program 22 sets “RELATED_PERSONS” in the user category (S250), and goes to S253. When the user 9 is not in the list of the related persons, the policy server A program 22 sets “ANY” in the user category (S251), and goes to S253.

When the document ID is not included in the security attribute in S245, the policy server A program 22 sets “ANY” in the user category (S252), and goes to S253.

Next, the policy server A program 22 refers to the document security policy 21 and specifies <Policy> in the following method. That is, in the specified <Policy>, <Category> and <Level> of <Resource> match with the estimated security attribute, <Category> and <Level> of <Subject> match with the category and the right level of the user 9, and <Actions> matches with the type of access in the document using right determination request (S253).

Then the policy server A program 22 executes the contents of <Obligation> in <Policy> (S254), and ends the processes.

When <Obligation> in <Policy> searched in S235 is not “REFER_PRIMARY_POLICY” in S243, the policy server A program 22 executes <Obligation> in <Policy> and ends the processes.

In S112 of the sequence chart shown in FIG. 11, the document using right determination request includes the scanned data which request is sent from the scanning program 3P to the policy server A program 22.

When the scanned data are included, the number of sending times of data from the scanning program 3P to the policy server A program 22 can be small. However, when it can be instantly determined that the user 9 does not have the document using right, since the scanned data are always sent, efficiency may be lowered. In order to prevent the efficiency from being lowered, a case is described. In this case, the scanned data are sent to the policy server A program 22 right before the end of the scanning processes.

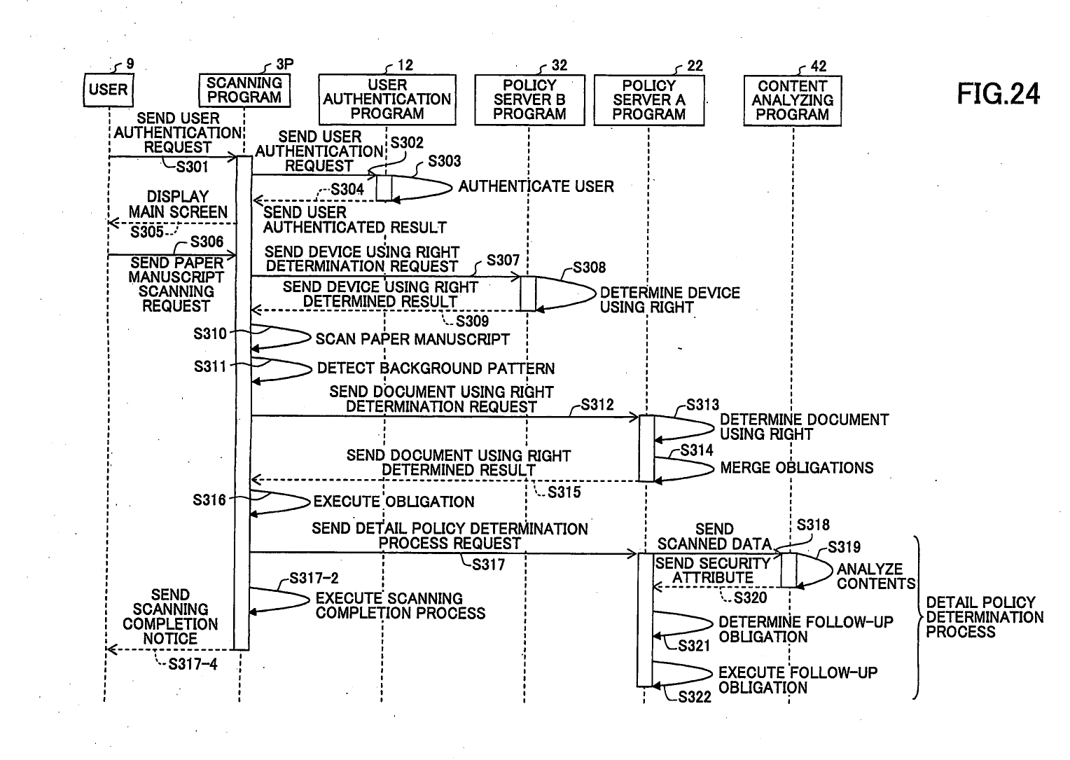

FIG. 24 is a sequence chart showing processes to scan the paper manuscript 3a in which scanned data are sent to the policy server A program 22 right before the end of the scanning processes. In FIG. 24, a request to a program is executed by a function call (continuous line), and a result processed by the function call is returned as a return value (dashed line).

Referring to FIG. 24, the processes are described. First, the user 9 requests to authenticate the user 9 by inputting user authentication information on the operating panel of the digital multifunctional apparatus 3 (S301). The scanning program 3P of the digital multifunctional apparatus 3 sends the request including the user authentication information to the user authentication server 10 (S302).

The user authentication program 12 in the user authentication server 10 authenticates the user 9 based on the user authentication information received from the digital multifunctional apparatus 3 (S303), and returns the user authenticated result to the scanning program 3P (S304).

When the user authenticated result shows successful, the scanning program 3P displays the main screen on the digital multifunctional apparatus 3 (S305). When the user authenticated result does not show successful, the scanning program 3P informs the user 9 of non-authentication and does not execute the processes by the user 9.

The user 9 sends a paper manuscript scanning request to the digital multifunctional apparatus 3 by putting on the paper manuscript 3a thereon (S306). In order to determine whether the user 9 has a right to use the digital multifunctional apparatus 3, the scanning program 3P of the digital multifunctional apparatus 3 sends a device using right determination request to the policy server B 30 to determine whether the user 9 has the device using right based on the paper manuscript scanning request (S307). In the device using right determination request, the user authenticated result, the device information, and the type of access (in this case, scanning) are designated.

The policy server B program 32 in the policy server B 30 determines whether the user 9 has the device using right by referring to the device security policy 31 and information in the device security attribute database 34 (S308), and returns the determined result to the scanning program 3P as the device using right determined result (corresponding to the policy determined result B shown in FIG. 8) (S309).

When the user 9 does not have the device using right, the scanning program 3P informs the user 9 of that the user 9 does not have the device using right for scanning the paper manuscript 3a and ends the processes. When the user 9 has the device using right, the scanning program 3P scans the paper manuscript 3a (S310). Then the scanning program 3P detects the background pattern of the paper manuscript 3a from data scanned the paper manuscript 3a (S311).

In order to determine whether the user 9 has a document using right, the scanning program 3P sends a document using right determination request to the policy server A 20 (S312). The document using right determination request includes the user authenticated result, real time detected information by the background pattern detection in S311, the type of the access (in this case, scanning), the device using right determined result (corresponding to the policy determined result B shown in FIG. 8). That is, the document using right determination request does not include the scanned data.

The policy server A program 22 in the policy server A 20 determines whether the user 9 has the document using right by referring to the document security policy 21 and information in the document security attribute database 24 (S313).

The policy server A program 22 in the policy server A 20 merges obligations designated by the document using right determined result and the device using right determined result by referring to the table TBL 50 shown in FIG. 9 and the obligation merging rule shown in FIG. 10 (S314).

The policy server A program 22 in the policy server A 20 sends the document using right determined result to the digital multifunctional apparatus 3 (S315).

When the scanning program 3P receives the document using right determined result from the policy server A program 22, the scanning program 3P executes the obligation designated by the document using right determined result (S316), and sends a detail policy determination process request including the scanned data to the policy server A program 22 in the policy server A 20 (S317).

The processes by the detail policy determination process request includes a content analyzing process (S319), a follow-up obligation determination process (S321), and a follow-up obligation executing process (S322).

When the policy server A program 22 receives the detail policy determination process request including the scanned data from the scanning program 3P, the policy server A program 22 obtains the scanned data included in the detail policy determination process request, and sends the scanned data to the content analyzing server 40 (S318).

The content analyzing program 42 in the content analyzing server 40 analyzes the contents of the scanned data (S319), and returns the analyzed result to the policy server A program 22 as the security attribute (S320).

The policy server A program 22 executes a follow-up obligation determination process based on the security attribute (S321), and executes a follow-up obligation process based on the follow-up obligation determined result (S322). For example, alert mail is sent to the administrator.

In the digital multifunctional apparatus 3, after sending the detail policy determination process request including the scanned data to the policy server A 20, the scanning program 3P executes a scanning completion process (S117-2).

The scanning program 3P sends a scanning completion notice to the user 9 as a return value for the request (S306) of scanning the paper manuscript 3a (S317-4). Then the digital multifunctional apparatus 3 displays the scanning completion on the operating panel and the user 9 recognizes the scanning completion.

For example, in the sequence chart shown in FIG. 24, after sending the detail policy determination process request to the policy server A program 22, only when “REFER_PRIMARY_POLICY” signifying that a primary policy is referred to is designated, the scanned data are sent to the policy server A 20, and the contents of the scanned data are analyzed.

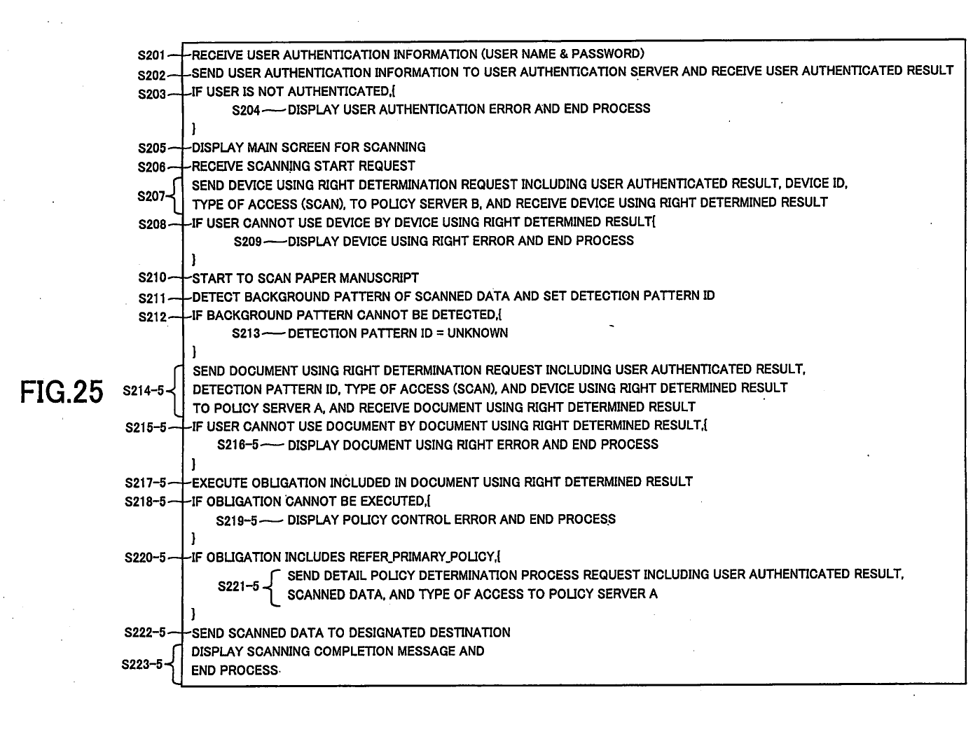

Referring to FIGS. 25 through 27, processes of a case are described. In this case, after executing an obligation, a detail policy determination process is executed.

FIG. 25 is a diagram showing processes to be executed by the scanning program 3P in a case where a detail policy determination process is executed after executing an obligation. In FIG. 25, the same step as that shown in FIG. 21 has the same step number and the description thereof is omitted. That is, the descriptions from S201 through S213 are omitted.

After detecting the background pattern of the scanned data and setting that the background pattern is the detection pattern ID (S211 through S213), the scanning program 3P sends a document using right determination request, which includes the user authenticated result, the detection pattern ID, the type of the access (scanning), and the device using right determined result, to the policy server A 20 and receives a document using right determined result from the policy server A 20 (S214-5). In this case, the scanned data are not included in the document using right determination request.

Then the scanning program 3P determines whether the document using right determined result shows successful (S215-5). When the document using right determined result does not show successful, the scanning program 3P displays a document using right error on the operating panel of the digital multifunctional apparatus 3 and ends the processes (S216-5).

When the Document Using Right Determined Result shows successful, the scanning program 3P executes an obligation which is included in the document using right determined result (S217-5). The scanning program 3P determines whether the obligation is executed (S218-5). When the obligation cannot be executed, the scanning program 3P displays a policy control error on the operating panel of the digital multifunctional apparatus 3 and ends the processes (S219-5).

When the obligation can be executed, the scanning program 3P determines whether “REFER_PRIMARY_POLICY” is included in the obligation (S220-5). When “REFER_PRIMARY_POLICY” is included in the obligation, the scanning program 3P sends a detail policy determination process request; which includes the user authenticated result, the scanned data, and the type of access (scanning); to policy server A 20 (S221-5).

After executing the obligation, the scanning program 3P outputs the scanned data to a designated destination (S222-5). Then the scanning program 3P displays a scanning completion message on the operating panel of the digital multifunctional apparatus 3 and ends the processes (S223-5).

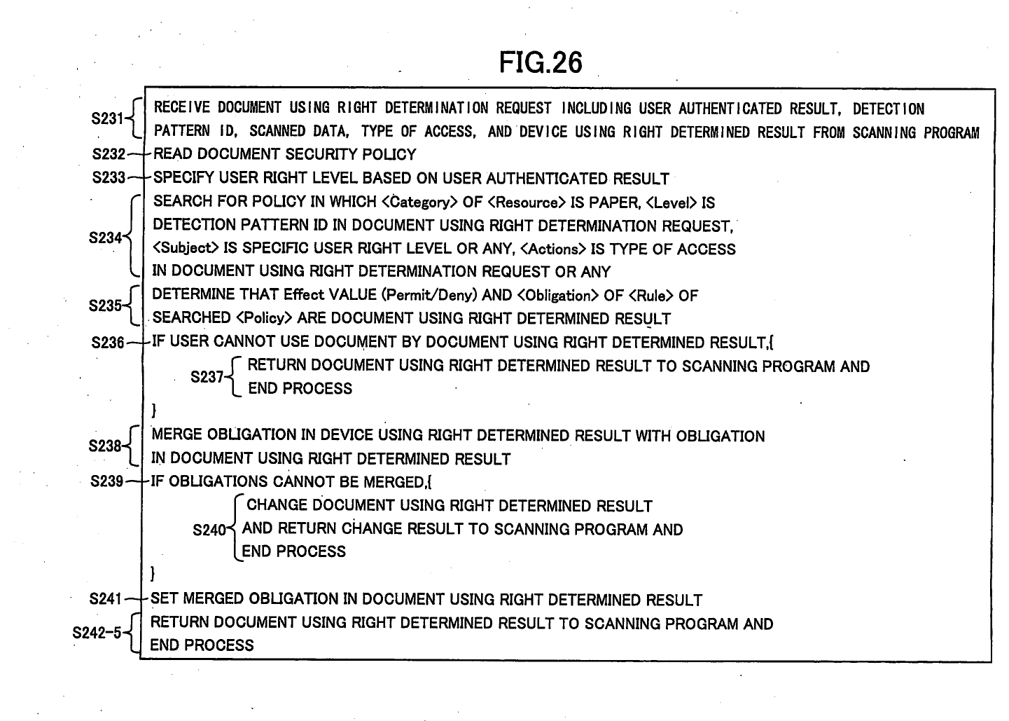

FIG. 26 is a diagram showing processes of the document using right determination process to be executed by the policy server A program 22 in a case where a detail policy determination process is executed after executing an obligation. In FIG. 26, the same step as that shown in FIG. 22 has the same step number and the description thereof is omitted. That is, the descriptions from S231 through S241 are omitted.

In the document using right determination process shown in FIG. 26, the policy server A program 22 executes the processes from S231 through s241, and sends the document using right determined result to the scanning program 3P without executing S243 through S255 shown in FIG. 23, and ends the processes (S242-5).

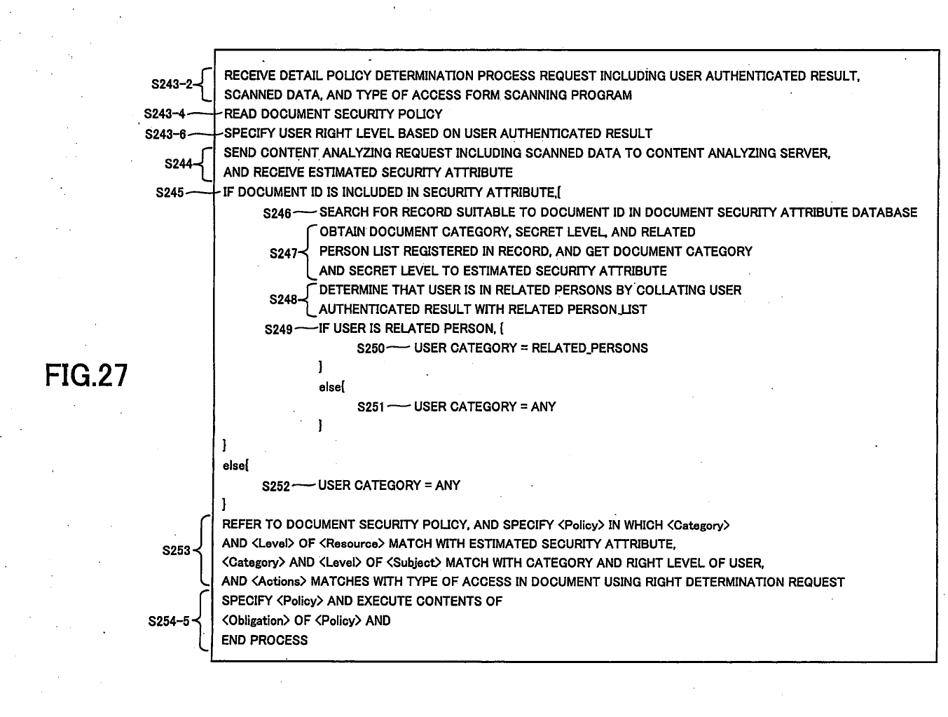

FIG. 27 is a diagram showing processes in the detail policy determination process to be executed by the policy server A program 22 after executing an obligation. In FIG. 27, the same step as that shown in FIG. 23 has the same step number and the description thereof is omitted.

In the detail policy determination process shown in FIG. 27, the policy server A program 22 receives a detail policy determination process request, which includes the user authenticated result, the scanned data, and the type of access (scanning), from the scanning program 3P of the digital multifunctional apparatus 3 (S243-2).

After receiving the detail policy determination process request, the policy server A program 22 reads the document security policy 21 (S243-4). In addition, the policy server A program 22 specifies the level of the user right based on the user authenticated result (S243-6).

After this, the policy server A program 22 executes the processes similar to those from S244 through S253 shown in FIG. 23, executes the contents of specified <Obligation> of <Policy>, and ends the processes (S254-5).

Next, specific examples are described. In a first example, in the document security system 100, Mr. Sakai of a regular staff copies a paper manuscript 3a (general document) by using the digital multifunctional apparatus 3 identified by “MFP000123” in a development section.

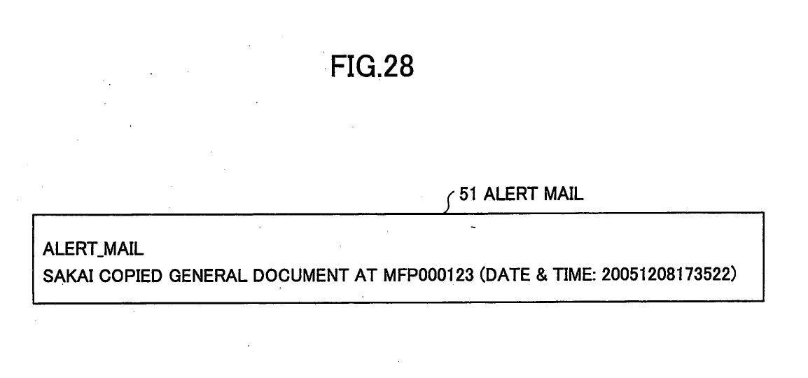

In this case, Mr. Sakai is not a related person “RELATED_PERSON” of the digital multifunctional apparatus 3 identified by “MFP000123”; however, Mr. Sakai is permitted to copy the general document. However, “ALERT_MAIL” is an obligation. In this case, alert mail 51 shown in FIG. 28 is sent to an administrator.

FIG. 28 is a diagram showing an example of the alert mail 51 which is sent to an administrator as an obligation when a general document is copied. In the alert mail 51 shown in FIG. 28, for example, a message “ALERT_MAIL SAKAI COPIED BY MFP000123 (DATE & TIME 20051208173522)” is displayed.

In a second example, in the document security system 100, Mr. Sakai of a regular staff copies a paper document 2c by using the digital multifunctional apparatus 3 identified by “MFP000123” in a development section. The paper document 2c is formed by printing a secured document 1c identified by “SEC000123” which is a confidential document in a personnel section. In the paper document 2c printed from the secured document 1c, a copy protection for preventing an unauthorized copy of a pattern No. 3 is printed.

In this case, Mr. Sakai is not a related person “RELATED_PERSON” of the digital multifunctional apparatus 3 identified by “MFP000123”; however, Mr. Sakai may be permitted to copy the paper document 2c corresponding to the device security policy 31. However, “ALERT_MAIL” is an obligation.

However, when Mr. Sakai copies the paper document 2c by using the digital multifunctional apparatus 3 identified by “MFP000123”, the pattern No. 3 is detected from the paper document 2c. Therefore, it is determined whether Mr. Sakai can copy the paper document 2c based on the document security policy 21. Since Mr. Sakai is a regular staff, Mr. Sakai can copy the paper document 2c; however, alert mail is an obligation.

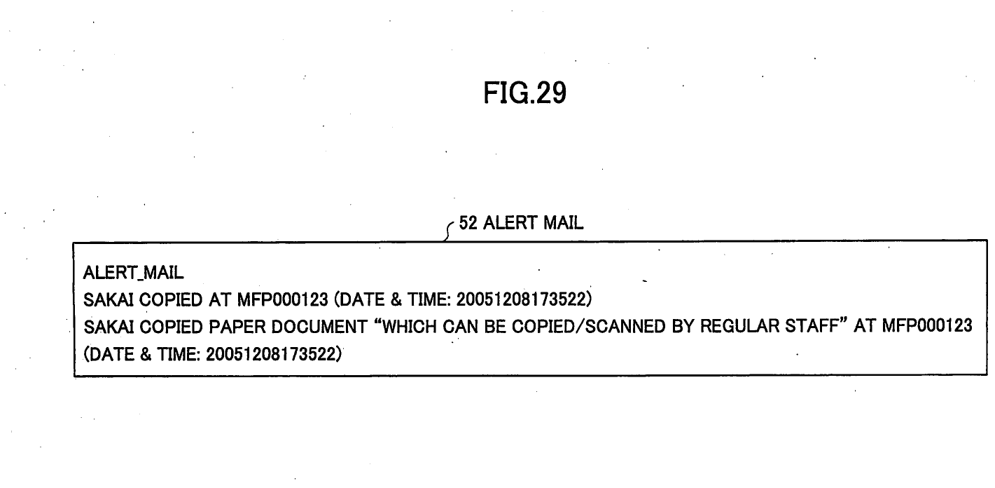

In this case, the obligation by the device security policy 31 and the obligation by the document security policy 21 (policy for the secured document 1c) are merged. Then alert mail shown in FIG. 29 is sent to an administrator.

FIG. 29 is a diagram showing an example of alert mail 52 which is sent to an administrator as an obligation when a paper document 2c printed from a secured document 1c is copied. In the alert mail 52 shown in FIG. 29, for example, a message “ALERT_MAIL, SAKAI COPIED BY MFP000123 (DATE & TIME 20051208173522), SAKAI COPIED PAPER DOCUMENT WHICH CAN BE COPIED/SCANNED BY REGULAR STAFF AT MFP000123 (DATE & TIME 20051208173522)” is displayed.

In a third example, in the document security system 100, Mr. Sakai of a regular staff scans a paper document 2c by using the digital multifunctional apparatus 3 identified by “MFP000123” in a development section. In this case, the paper document 2c is different from that in the second example. The paper document 2c is formed by printing an original document 1b of a secured document 1c identified by “SEC000123” which is a confidential document in a personnel section. In the paper document 2c printed from the original document 1b, a pattern is not printed.

In this case, since Mr. Sakai is not a related person “RELATED_PERSON” of the digital multifunctional apparatus 3 identified by “MFP000123”, an image analysis is applied to scanned data obtained from scanning the paper document 2c based on the document security policy 21 as an obligation.

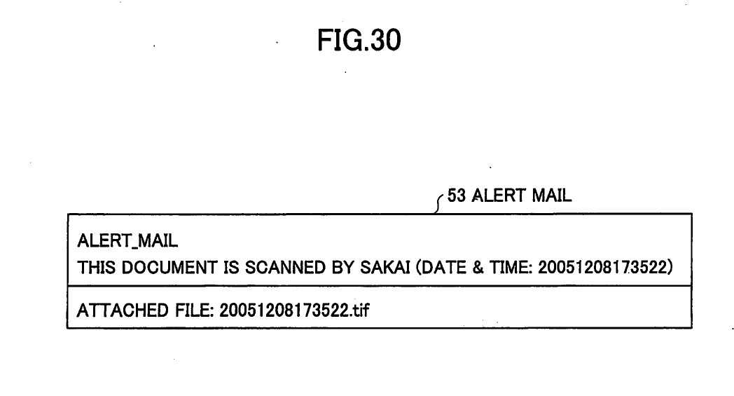

From the image analysis, when it is determined that the paper document 2c is a confidential document in the personnel section identified by “SEC000123” and Mr. Sakai is not a related person to the personnel section, alert mail shown in FIG. 30 is sent to an administrator as a follow-up obligation based on the document security policy 21.

FIG. 30 is a diagram showing an example of alert mail 53 which is sent to an administrator as a follow-up obligation when a paper document 2c printed from an original document 1b is scanned. In the alert mail 53 shown in FIG. 30, for example, a message “ALERT_MAIL, SAKAI SCANNED THIS DOCUMENT (DATE & TIME 20051208173522), ATTACHED FILE: 20051208173522.tif” is displayed. That is, the attached file “20051208173522.tif” is sent to the administrator together with the message.

As described above, according to the embodiment of the present invention, in the document security system 100, a process requested by a user is executed when the process is permitted from the device using right of the user and the document using right of the user, and an obligation and a follow-up obligation are executed based on the type of the access obtained from the image data.

Further, the present invention is not limited to the embodiment, but various variations and modifications may be made without departing from the scope of the present invention.

The patent application is based on Japanese Priority Patent Application No. 2006-128557 filed on May 2, 2006, with the Japanese Patent Office, the entire contents of which are hereby incorporated herein by reference.

1. A document security system, comprising:
a receiving unit which receives a request for processing a document from a user;
a first determined result obtaining unit which obtains a first determined result by determining whether the process requested according to a device using right of the user is given a permission for processing by referring to a device security policy in which the device using right of the user is defined;
a document type determining unit which determines the type of the document based on identifying information by obtaining the identifying information attached to the document from image data obtained by scanning the document;
a second determined result obtaining unit which obtains a second determined result by determining whether the type of the document determined by the document type determining unit is permitted to perform the process requested by the request by referring to a document security policy in which the document using right of the user is defined;
a process executing unit which executes the process for the document requested by the user when both the first determined result and the second determined result is affirmative;
an analyzing unit which analyzes the image data obtained by scanning the document; and
a follow-up obligation executing unit which executes a follow-up obligation according to the document security policy based on information obtained by the analyzing unit after executing the process for the document requested by the user.

2. The document security system as claimed in claim 1, further comprising:
an obligation merging unit which merges an obligation included in the first determined result with an obligation included in the second determined result according to a predetermined merging rule when both the first determined result and the second determined result show permission.

3. The document security system as claimed in claim 2, wherein:
when the obligation merged by the obligation merging unit cannot be executed, the process for the document requested by the user is not executed.

4. The document security system as claimed in claim 1, wherein:
the process for the document requested by the user is to copy the document, to scan the document, or to facsimile the document.

5. A digital multifunctional apparatus, comprising:
a real time paper document determining unit which determines the type of a paper document based on identifying information by obtaining the identifying information attached to the paper document from image data obtained by scanning the paper document;
a document using right determining unit which determines whether a user who requests to process the paper document has a document using right for using the paper document for processing the paper document of the type of the paper document determined by the real time paper document determining unit by referring to a document security policy in which the document using right of the user is defined;
a paper document processing unit which processes the paper document by changing process contents based on a determined result by the document using right determining unit; and
a paper document detail policy determination process requesting unit which sends a detail policy determination process request including the process contents for the paper document to a predetermined destination.

6. A program product for processing a paper document in the digital multifunctional apparatus as claimed in claim 5, comprising:
a real time paper document determining step which determines the type of a paper document based on identifying information by obtaining the identifying information attached to the paper document from image data obtained by scanning the paper document;
a document using right determining step which determines whether a user who requests to process the paper document has a document using right for using the paper document for processing the paper document of the type of the paper document determined by the real time paper document determining step by referring to a document security policy in which the document using right of the user is defined;
a paper document processing step which processes the paper document by changing a process content based on a determined result by the document using right determining step; and
a paper document detail policy determination process requesting step which sends a detail policy determination process request including the process contents for the paper document to a predetermined destination.

7. A policy server, comprising:
a policy processing request receiving unit which receives a policy processing request including document contents from an external device;
a security attribute estimating unit which estimates a security attribute of the document contents received by the policy processing request receiving unit;
a policy determining unit which determines a security policy based on the estimated security attribute; and
an obligation executing unit which executes an obligation including in a determined result by the policy determining unit.

8. The policy server as claimed in claim 7, wherein:
the policy processing request receiving unit receives a policy processing request which includes a document processing request and a document attribute of the document contents from the external device; and
the policy server further includes
a real time policy determining unit which determines a security policy in real time based on the document attribute and sends a determined result to the external device which is a source of the policy processing request.

9. A program product for executing processes in a security server in the document security system as claimed in claim 1, comprising:
a policy processing request receiving step which receives a policy processing request including document contents from an external device;
a security attribute estimating step which estimates a security attribute of the document contents received by the policy processing request receiving step;
a policy determining step which determines a security policy based on the estimated security attribute; and
an obligation executing step which executes an obligation included in a determined result by the policy determining step.

10. The program product for executing processes in the security server as claimed in claim 9, wherein:
the policy processing request receiving step receives a policy processing request which includes a document processing request and a document attribute of the document contents from the external device; and
the program product for executing processes in the security server further includes
a real time policy determining step which determines a security policy in real time based on the document attribute and sends a determined result to the external device which is a source of the policy processing request.
